(19) United States
(12) Patent Application Publication
(10) Pub. No.: US 2012/0281030 A1
(43) Pub. Date: Nov. 8, 2012

(54) DISPLAY DEVICE, AND METHOD FOR DRIVING DISPLAY DEVICE

(75) Inventor: Hidekazu Miyata, Osaka-shi (JP)

(73) Assignee: Sharp Kabushiki Kaisha, Osaka-shi (JP)

(21) Appl. No.: 13/520,774

(22) PCT Filed: Oct. 15, 2010
(86) PCT No.: PCT/JP2010/068201

§ 371 Date: Jul. 5, 2012

(30) Foreign Application Priority Data
Jan. 8, 2010 (JP) 2010-003389

(51) Int. Cl. G09G 5/10

(52) U.S. Cl. 345/690

(57) ABSTRACT

The present invention provides a method for suppressing a crosstalk without performing complicated correction calculation. The liquid crystal display device (10) includes an active matrix substrate having gate lines, source lines, pixel electrodes having any of colors constituting an image. The liquid crystal display device (10) includes an RGB reconfiguring section (12) for reconfiguring the tones between identical-colored pixel electrodes in each of areas into which a display area is divided. The reconfiguring section (i) calculates a difference between (a) a tone of a pixel electrode provided between adjacent two source lines and connected with one of the adjacent two source lines and (b) a tone of a pixel electrode connected with the other of adjacent two source lines and (ii) reconfigures tones of the respective pixel electrodes such that the difference becomes smaller than a difference which has not been reconfigured.

### REFERENCE TO RELATED APPLICATIONS

This application is a national stage application under USC 371 of International Application No. PCT/JP2010/068201, filed Oct. 15, 2010, which claims priority from Japanese Patent Application No. 2010-003389 filed Jan. 8, 2010, the entire contents of which are incorporated herein by reference.

### FIELD OF THE INVENTION

The present invention relates to (i) a method for driving an active matrix display device, in which switching elements such as thin-film transistors are arranged in a matrix manner, and (ii) a display device which employs the method.

### BACKGROUND OF THE INVENTION

According to an active matrix display device such as a TFT liquid crystal panel, when voltages (data) are applied to respective pixels, states (luminance) of the respective pixels are maintained so as to display an image with the states (luminance) for one (1) frame period, until other voltages are next applied to the respective pixels. According to a display carried out by a device such as a general television device, data is rewritten for each frame frequency, and therefore a constant luminance corresponding to the data is maintained for one (1) frame period in the pixels of the TFT liquid crystal panel. Such a display mode is called “hold mode”.

A TFT liquid crystal panel includes a TFT substrate and a counter substrate between which a liquid crystal layer is provided. The counter substrate has a surface on which a counter electrode is provided. TFT elements are provided on the TFT substrate for respective pixels. The TFT elements have respective drains which are connected with respective pixel electrodes. A plurality of source lines and a plurality of gate lines are provided on the TFT substrate in a matrix manner. Each of the plurality of source lines is used to supply a data voltage to a corresponding one of the TFT elements, and each of the plurality of gate lines is used to turn ON a corresponding one of the TFT elements. The TFT elements are provided in the vicinity of respective intersections of the plurality of source lines and the plurality of gate lines. Each of the TFT elements has (i) a source connected with a corresponding one of the plurality of source lines and (ii) a gate connected with a corresponding one of the plurality of gate lines.

According to the TFT liquid crystal panel thus configured, the TFT element is turned ON when a voltage (gate voltage) of the gate line is High, and then a voltage (source voltage) of the source line is applied to a pixel electrode on a drain side of the TFT element. When the gate voltage is Low, the TFT element is turned OFF, and an electric charge of the pixel electrode is maintained.

The description above discusses a panel configuration for controlling an arrangement of liquid crystal molecules by an electric field, which is in a direction substantially perpendicular to the panel, such as of a TN (Twisted Nematic) mode. Note, however, that the description applies also to a driving mode utilizing an electric field, which is in a direction substantially in parallel with the panel, such as of an IPS (In Panel Switching) mode, except that a counter electrode is provided on a TFT substrate. The following description will discuss, as an example, a TFT panel employing the TN mode.

(Dot-Reversal Driving and Line-Reversal Driving)

FIG. 19 is an equivalent circuit illustrating a conventional TFT liquid crystal panel. Conventionally, in a case where such a TFT liquid crystal panel is driven, (i) an electric potential difference between a pixel electrode and a counter electrode, which electric potential difference corresponds to a transmittance of a tone, is defined as an electric potential difference for obtaining a liquid crystal molecular orientation having the transmittance and (ii) a voltage is applied to the pixel electrode such that a polarity of the pixel electrode alternates between a positive polarity and a negative polarity for each frame. In this case, the “polarity” indicates a polarity of a voltage with respect to an electric potential of the counter electrode. Hereinafter, the term “polarity” is used in the meaning thus defined. The liquid crystal is thus AC-driven. In a case where voltages having identical polarities are applied to all the pixels in the TFT liquid crystal panel and the polarities are alternated for each frame between positive and negative, flickers are caused by a slight electric potential difference between the positive and negative polarities, and therefore image quality is deteriorated. In order to improve such image quality deterioration, a method is employed such as (i) a line-reversal driving in which a polarity is changed for each line in one (1) frame period or (ii) a dot-reversal driving in which a polarity is changed for each pixel in one (1) frame period.

According to the dot-reversal driving, positive polarities and negative polarities alternately exist in a single screen. This makes it possible to reduce the flickers. The line-reversal driving has been employed in a number of panels, such as a VGA panel, having low resolution. In recent years, however, the dot-reversal driving is employed in most of high definition panels, which have high resolution, and large-screen panels.

In a case where a panel is driven, which has a configuration as illustrated by the equivalent circuit of FIG. 19, supplied pixel data is stored in a source driver, and when data for one (1) line is stored, (i) a scanning line (gate voltage) is controlled to be High so as to turn ON a TFT and (ii) simultaneously a data voltage is applied to a source line by the source driver. In a case where the line-reversal driving or the dot-reversal driving is employed, a voltage, which is applied to a pixel connected to a source line via a TFT, is reversed in polarity for each line. That is, a polarity of a voltage applied to a pixel differs for each line.

(Color Crosstalk Caused in Dot-Reversal Driving and Line-Reversal Driving)

As above described, according to the conventional TFT panel in which a different voltage is applied to each source line, a pixel voltage is changed by a parasitic capacitor caused between the pixel electrode and a source line. Such a change in pixel voltage is called “feed-through pixel voltage”. In a case where a feed-through pixel voltage is caused, a phenomenon is caused in which a voltage of a pixel electrode is changed, and therefore a desired tone cannot be obtained (this phenomenon is called “crosstalk”).

In particular, according to a TFT panel for displaying a color image, three pixel sections are adjacently provided for forming respective red (R), green (G), and blue (B) pixels, which constitute a display unit of a color image. In a case where crosstalks differently affect (in degree and/or direction) respective electric potentials of three pixel electrodes, which are included in the respective three pixel sections corresponding to a display unit, a phenomenon (called “color crosstalk”) is caused in which a desired color cannot be displayed.

The following description will discuss the crosstalk.

FIG. 20 is an explanatory view for explaining a principle of how a crosstalk is caused. (a) of FIG. 20 is a view schematically illustrating a parasitic capacitor caused between a pixel and respective two source lines between which the pixel is provided. (b) of FIG. 20 is a view schematically illustrating a state where a feed-through pixel voltage is caused.

A pixel of a TFT panel is provided between two source lines, and a parasitic capacitor is caused between the pixel and the respective two source lines (see (a) of FIG. 20). In a case where a voltage is applied to the pixel, a voltage of a gate line, which is connected with a TFT of the pixel, is controlled to become High so that the TFT is turned ON during a horizontal period, and a voltage applied to a source line is applied to the pixel via the TFT. In a case where the voltage of the gate line becomes Low, the TFT is turned OFF, and an electric charge applied to a pixel electrode corresponding to the pixel is maintained, and therefore the voltage of the pixel is maintained. However, as above described, there is the parasitic capacitor between the pixel and the source line, and therefore the voltage of the pixel is changed when the voltage of the source line is changed, because of an electric potential difference from the source line (see (b) of FIG. 20).

FIG. 21 is a schematic view illustrating an example of a change in pixel voltage caused when a dot-reversal driving is carried out in a conventional TFT panel. FIG. 21 illustrates a feed-through pixel voltage which is caused, in a dot-reversal panel having four scanning lines, when (i) a voltage, which is largely different from a voltage of a counter electrode, is applied to a pixel (target pixel) and (ii) a voltage, which is not different from the voltage of the counter electrode, is applied to a second source line which is adjacent to the target pixel. (a) of FIG. 21 illustrates a change in voltage of a first source line (which is connected with the target pixel via a TFT). (b) of FIG. 21 illustrates a change in voltage of the second source line. (c) of FIG. 21 illustrates a change in voltage of the target pixel. In the case illustrated in FIG. 21, the voltage of the target pixel is affected by the voltage of the first source line.

FIG. 22 is a view illustrating an example of a change in pixel voltage caused when identical data voltages are applied to the first source line and the second source line of the dot-reversal panel shown in FIG. 21. (a) of FIG. 22 illustrates a change in voltage of the first source line (which is connected with the target pixel via the TFT). (b) of FIG. 22 illustrates a change in voltage of the second source line. (c) of FIG. 22 illustrates a change in voltage of the target pixel.

As is shown by a comparison between FIGS. 21 and 22, a display luminance of the target pixel differs between (i) a case where, for example, different voltages are applied to the first source line and the second source line for carrying out a display with only red and (ii) a case where, for example, identical voltages are applied to the first source line and the second source line for carrying out a display with all colors. This is the reason why a color crosstalk is caused.

(Typical Examples of Color Crosstalk)

The following description will discuss (i) examples in which a color crosstalk is caused and (ii) examples in which no color crosstalk is caused.

First, the following description will discuss two examples in which no color crosstalk is caused.

As a first example, in a case of a white solid display (e.g., all pixels have a tone level of 96 as illustrated in FIG. 23), a voltage as illustrated in FIG. 22 is applied to each of the pixels of RGB, and therefore no change in luminance ratio of RGB is caused by a change in pixel voltage caused by a feed-through voltage.

A second example is a case where a tone level of 0 and a tone level of 96 are alternated for each pixel (see FIG. 24). In such a case, even though an output luminance becomes an average of the tone level of 0 and the tone level of 96, a voltage as illustrated in FIG. 21 is applied to each of the pixels of RGB, because pixels, which are adjacent to respective pixels of RGB having the tone level of 96, have the tone level of 0. Consequently, a luminance is decreased in all the pixels. However, voltages of the respective pixels of RGB are decreased by identical voltages, and therefore a shift in chromaticity is not caused.

The following description will discuss three examples in which a color crosstalk is caused.

A first example is a case where a tone level of 0 and a tone level of 96 are alternated for each picture element (see FIG. 25). Here, one (1) picture element is made up of a red pixel, a green pixel, and a blue pixel. In this case, each blue pixel has a tone different from that of a corresponding adjacent pixel, whereas each red pixel and each green pixel has a tone (i.e., tone level of 96) identical with a corresponding adjacent pixel. Therefore, a voltage, which is applied to each of the red and green pixels having the tone level of 96, becomes a voltage, which is not a feed-through voltage as illustrated in FIG. 22. Whereas, a voltage applied to each of the blue pixels becomes a feed-through voltage as illustrated in FIG. 21. Under the circumstances, in a case of a normally black panel, a luminance of blue becomes lower than those of red and green, and output chromaticity is shifted toward a yellow side.

A second example is a case where the pixels have respective tones as illustrated in FIG. 26. In this case, for the same reason above described, a voltage applied to each of the green pixels (having the tone level of 96) becomes a feed-through voltage as illustrated in FIG. 21, whereas, a voltage applied to each of the red and blue pixels becomes a voltage as illustrated in FIG. 22. Therefore, chromaticity is shifted toward a purple side.

A third example is a case where the pixels have respective tones as illustrated in FIG. 27. In this case, for the same reason above described, a voltage applied to each of the red pixels (having the tone level of 96) becomes a feed-through voltage as illustrated in FIG. 21, whereas, a voltage applied to each of the green and blue pixels becomes a voltage, which is not a feed-through voltage, as illustrated in FIG. 22. Therefore, chromaticity is shifted toward a light blue side.

Patent Literature 1 discloses a method for improving the color crosstalk. In the method of Patent Literature 1, an input signal (data) is converted with reference to two types of look-up tables (basic look-up table and detailed look-up table), which have been prepared by calculating correction values in advance. The basic look-up table stores a tone correction amount associated with each combination of a first display tone and second display tone, between which a predetermined space is provided. Note that the first display tone is a tone to be inputted to a target pixel, and the second display tone is a tone to be inputted to an adjacent pixel adjacent to the target pixel. The detailed look-up table stores a tone correction amount for each combination of display tones between which a space, which is smaller than the predetermined space, is provided. Patent Literature 1 discloses that more appropriate correction can be carried out by obtaining a tone correction amount with reference to the two types of look-up tables.
Japanese Patent Application Publication Tokukai No. 2007-178561 A (Publication date: Jul. 12, 2007)

### SUMMARY OF THE INVENTION

According to the method of Patent Literature 1, correction value data is outputted, with the use of the look-up tables and an operation, based on a combination of (i) data to be written into the target pixel and (ii) data to be written into the adjacent pixel. However, during a voltage is maintained in a pixel, a change in the voltage caused by a capacity coupling with a source line connected with the pixel and an adjacent source line affects a display luminance of the pixel (see FIG. 21). Therefore, in order to take into consideration a feed-through voltage caused by the capacity coupling with the adjacent source line, it is necessary to consider pieces of data supplied to respective source lines during one (1) frame period, in addition to the data to be written into the adjacent pixel and the data to be written into the target pixel. That is, an appropriate correction value cannot be outputted based on only the pieces of data to be written into respective of the target pixel and the adjacent pixel.

As above described, a change in data supplied to the adjacent source line during one (1) frame period affects a change in voltage applied to the target pixel. Under the circumstances, in a case where data to be written into the target pixel is corrected and then supplied to the source line as in the method of Patent Literature 1, a calculation needs to be carried out so that a feed-through voltage is corrected by taking into consideration (i) corrected data to be written into the target pixel via one vertical line (source line) and (ii) data to be written into the adjacent pixel via another vertical line. In such a case, it is required to provide a memory for storing data of one (1) frame. Moreover, it is necessary to carry out an enormous amount of operations, which is nearly impossible to be carried out by the process using the look-up tables. That is, there have been many cases where the correction cannot be carried out by using a correction value calculated by a simple correction calculation.

The present invention is accomplished in view of the problem, and its object is to provide a method for suppressing a crosstalk without carrying out a complicated correction calculation.

In order to attain the object, a display device of the present invention includes an active matrix substrate, the active matrix substrate including: a plurality of gate lines; a plurality of source lines provided so as to intersect with the plurality of gate lines; a first plurality of pixel electrodes each of which is provided (i) between corresponding adjacent two of the plurality of source lines and (ii) between corresponding adjacent two of the plurality of gate lines, each of the first plurality of pixel electrodes being provided for a color of a plurality of colors with which an image is to be constituted; and a plurality of switching elements provided in the vicinity of respective intersections of the plurality of gate lines and the plurality of source lines, each of the plurality of switching elements being connected with a corresponding one of the plurality of gate lines and a corresponding one of the plurality of source lines, each of the first plurality of pixel electrodes causing image to be displayed in accordance with a transmittance corresponding to a predetermined tone by electrically connecting (i) the corresponding one of the plurality of source lines which is connected to a corresponding one of the plurality of switching elements with (ii) the each of the first plurality of pixel electrodes when a scanning signal, indicative of instructions on electrical conduction, is supplied to the corresponding one of the plurality of gate lines connected to the corresponding one of the plurality of switching elements, the display device further including: a reconfiguring section for reconfiguring the tones between respective identical-colored ones of a second plurality of pixel electrodes in each of a plurality of areas into which a display area of the display device is divided, each of the plurality of areas containing the second plurality of pixel electrodes included in the first plurality of pixel electrodes, the reconfiguring section (i) calculating a first difference between (a) a first tone of a first pixel electrode, which is provided between corresponding adjacent two of the plurality of source lines and is connected with one of the corresponding adjacent two of the plurality of source lines and (b) a second tone of a second pixel electrode connected with the other of the corresponding adjacent two of the plurality of source lines and (ii) reconfiguring tones of the respective second plurality of pixel electrodes such that the first difference becomes smaller than a first difference which has not been reconfigured.

In order to attain the object, a method for driving a display device of the present invention is a method for driving a display device which includes an active matrix substrate, the active matrix substrate including: a plurality of gate lines; a plurality of source lines provided so as to intersect with the plurality of gate lines; a first plurality of pixel electrodes each of which is provided (i) between corresponding adjacent two of the plurality of source lines and (ii) between corresponding adjacent two of the plurality of gate lines, each of the first plurality of pixel electrodes being provided for a color of a plurality of colors with which an image is to be constituted; and a plurality of switching elements provided in the vicinity of respective intersections of the plurality of gate lines and the plurality of source lines, each of the plurality of switching elements being connected with a corresponding one of the plurality of gate lines and a corresponding one of the plurality of source lines, each of the first plurality of pixel electrodes causing image to be displayed in accordance with a transmittance corresponding to a predetermined tone by electrically connecting (i) the corresponding one of the plurality of source lines which is connected to a corresponding one of the plurality of switching elements with (ii) the each of the first plurality of pixel electrodes when a scanning signal, indicative of instructions on electrical conduction, is supplied to the corresponding one of the plurality of gate lines connected to the corresponding one of the plurality of switching elements, the method including the steps of: (i) dividing a display area of the display device into a plurality of areas, each of which contains a second plurality of pixel electrodes included in the first plurality of pixel electrodes; (ii) calculating a first difference between (a) a first tone of a first pixel electrode, which is provided between corresponding adjacent two of the plurality of source lines and is connected with one of the corresponding adjacent two of the plurality of source lines and (b) a second tone of a second pixel electrode connected with the other of the corresponding adjacent two of the plurality of source lines; and (iii) reconfiguring the tones between respective identical-colored ones of the second plurality of pixel electrodes in each of the plurality of areas such that the first difference becomes smaller than a first difference which has not been reconfigured.

Here, “reconfiguring the tones between respective identical-colored ones of the second plurality of pixel electrodes in each of the plurality of areas” means (i) to interchange tones between the identical-colored ones of the second plurality of pixel electrodes in each of the plurality of areas or (ii) to change, by the reconfiguration, an allocation of tones to the respective identical-colored ones of the second plurality of pixel electrodes without changing a luminance obtained by all the identical-colored ones of the second plurality of pixel electrodes in each of the plurality of areas.

According to the configuration or the method, (i) the first difference is calculated between (a) the first tone of the first pixel electrode, which is connected with one of the corresponding adjacent two of the plurality of source lines and (b) the second tone of the second pixel electrode connected with the other of the corresponding adjacent two of the plurality of source lines and (ii) the tones are reconfigured such that the first difference becomes smaller than a first difference which has not been reconfigured. With the configuration, it is possible to reduce a phenomenon called “feed-through pixel voltage”, in which phenomenon a voltage of the first pixel electrode is changed by a parasitic capacitor caused between the voltage of the first pixel electrode and a voltage of the other of the corresponding adjacent two of the plurality of source lines. This makes it possible to suppress a crosstalk.

According to the configuration or the method, a crosstalk is suppressed by carrying out the reconfiguration of the tones of the respective pixel electrodes by the method above described. It is therefore possible to carry out the data processing by an operation simpler than that employed in a conventional method.

According to the configuration or the method of the present invention, it is possible to suppress a crosstalk without carrying out a complicated correction calculation.

According to the display device or the method of the present invention, it is possible to suppress a crosstalk without carrying out a complicated correction calculation.

### BRIEF DESCRIPTION OF THE DRAWINGS

FIG. 1 is a block diagram illustrating a configuration of a liquid crystal display device, in accordance with an embodiment of the present invention.

FIG. 2 is a cross-sectional view illustrating a configuration of a TFT liquid crystal panel included in the liquid crystal display device illustrated in FIG. 1.

FIG. 3 is a plane view illustrating a configuration of the TFT liquid crystal panel included in the liquid crystal display device illustrated in FIG. 1.

FIG. 4 is a schematic view illustrating a pixel array in the TFT liquid crystal panel illustrated in FIG. 3.

FIG. 5 is a schematic view illustrating an example of tones of the pixel array illustrated in FIG. 4, which have not been reconfigured.

FIG. 6

(a) of FIG. 6 is a schematic view illustrating an example of a pixel array, which is obtained by reconfiguring the pixel array illustrated in FIG. 5. (b) of FIG. 6 is a schematic view illustrating an example of tones of a pixel array, which is obtained by reconfiguring the pixel array illustrated in FIG. 5.

FIG. 7

(a) of FIG. 7 is a table illustrating x-y chromaticity obtained in a case where a reconfiguration process similar to that of FIG. 6 is carried out with respect to all pixels in a display area of a TFT liquid crystal panel. (b) of FIG. 7 is a graph illustrating x-y chromaticity obtained in a case where a reconfiguration process similar to that of FIG. 6 is carried out with respect to all pixels in a display area of a TFT liquid crystal panel.

FIG. 8

(a) of FIG. 8 is a schematic view illustrating another example of a pixel array, which is obtained by reconfiguring the pixel array illustrated in FIG. 5. (b) of FIG. 8 is a schematic view illustrating another example of tones of a pixel array, which is obtained by reconfiguring the pixel array illustrated in FIG. 5.

FIG. 9

(a) of FIG. 9 is a table illustrating x-y chromaticity obtained in a case where a reconfiguration process similar to that of FIG. 8 is carried out with respect to all pixels in a display area of a TFT liquid crystal panel. (b) of FIG. 9 is a graph illustrating x-y chromaticity obtained in a case where a reconfiguration process similar to that of FIG. 8 is carried out with respect to all pixels in a display area of a TFT liquid crystal panel.

FIG. 10 is a graph illustrating spatial frequency characteristics of luminance and chromaticity.

FIG. 11 is a block diagram illustrating a configuration of a liquid crystal display device of Embodiments 2 and 3 of the present invention.

FIG. 12 is a schematic view illustrating a pixel array in a TFT liquid crystal panel of Embodiment 2.

FIG. 13 is a schematic view illustrating an example of tones of the pixel array illustrated in FIG. 12, which have not been reconfigured.

FIG. 14

(a) of FIG. 14 is a schematic view illustrating an example of a pixel array, which is obtained by reconfiguring the pixel array illustrated in FIG. 12. (b) of FIG. 14 is a schematic view illustrating an example of tones of a pixel array, which is obtained by reconfiguring the pixel array illustrated in FIG. 12.

FIG. 15 is a schematic view illustrating a pixel array in a TFT liquid crystal panel of Embodiment 3.

FIG. 16 is a schematic view illustrating an example of tones of the pixel array illustrated in FIG. 15, which have not been reconfigured.

FIG. 17 is a schematic view illustrating an example of tones of a pixel array, which is obtained by reconfiguring the pixel array illustrated in FIG. 16.

FIG. 18 is a schematic view illustrating another example of a pixel array of a TFT liquid crystal panel included in a liquid crystal display device of the present invention.

FIG. 19 is an equivalent circuit diagram illustrating a conventional TFT liquid crystal panel.

FIG. 20 is an explanatory view for explaining a principle of how a crosstalk is caused.

FIG. 21 is a schematic view illustrating an example of a change in pixel voltage, which is caused when a dot-reversal driving is carried out in the conventional TFT panel.

FIG. 22 is a schematic view illustrating another example of a change in pixel voltage, which is caused when a dot-reversal driving is carried out in the conventional TFT panel.

FIG. 23 is a schematic view illustrating a first example in which no color crosstalk is caused.

FIG. 24 is a schematic view illustrating a second example in which no color crosstalk is caused.

FIG. 25 is a schematic view illustrating a first example in which a color crosstalk is caused.

FIG. 26 is a schematic view illustrating a second example in which a color crosstalk is caused.

FIG. 27 is a schematic view illustrating a third example in which a color crosstalk is caused.

### DETAILED DESCRIPTION OF THE INVENTION

### Embodiment 1

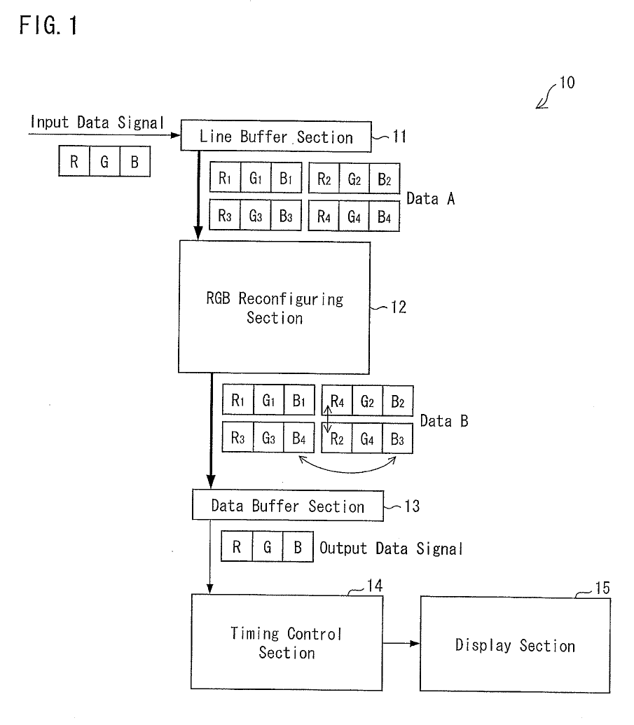

The following description will discuss Embodiment 1 of the present invention, with reference to FIGS. 1 through 10. Note that the present invention is not limited to Embodiment 1.

As an example of a display device of the present invention, the following description will discuss an active matrix color liquid crystal display device of Embodiment 1, which includes TFTs serving as switching elements and carries out a dot-reversal driving.

(Schematic Configuration of Liquid Crystal Display Device)

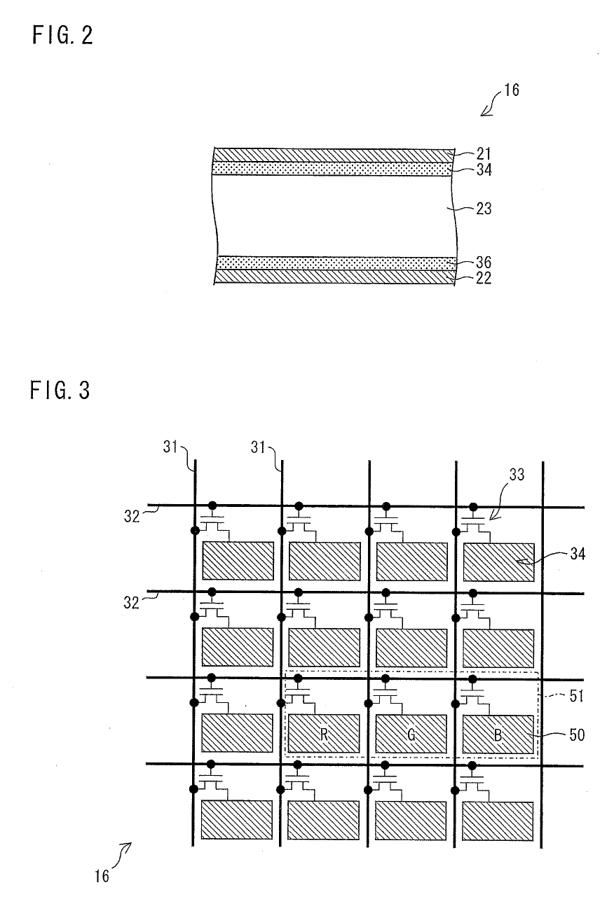

FIG. 1 illustrates a configuration of a liquid crystal display device 10 of Embodiment 1. The liquid crystal display device 10 includes a high resolution and high definition TFT liquid crystal panel, such as full high definition (FHD) or 4K2K. The liquid crystal display device mainly includes a line buffer section 11, an RGB reconfiguring section 12, a data buffer section 13, a timing control section 14, and a TFT liquid crystal panel (display section) 15 (see FIG. 1). FIG. 2 is a cross-sectional view schematically illustrating a cross-sectional configuration of the TFT liquid crystal panel 15. FIG. 3 is a plane view illustrating a planar configuration of the TFT liquid crystal panel 15.

The TFT liquid crystal panel 15 is configured so that a liquid crystal layer 23 is provided between a TFT substrate and a counter substrate 22 (see FIG. 2). A counter electrode 36 is provided over the counter substrate 22. There are provided, on the TFT substrate 21, TFT elements for respective pixels. The TFT elements have respective drains which are connected with respective pixel electrodes 34.

A plurality of source lines 31 and a plurality of gate lines 32 are provided on the TFT substrate 21 in a matrix manner (see FIG. 3). Data voltages are supplied to TFT elements 33 via the respective plurality of source lines 31, and some of the TFT elements 33 are turned ON in response to a voltage supplied via a corresponding gate line 32. The TFT elements 33 are provided in the vicinity of respective intersections of the plurality of source lines 31 and the plurality of gate lines 32. Each of the TFT elements 33 has (i) a source connected with a corresponding one of the plurality of source lines 31 and (ii) a gate connected with a corresponding one of the plurality of gate lines 32. As above described, the TFT elements 33 have drains connected with the respective pixel electrodes 34. Each of color filters of red (R), green (G), and blue (B) is provided on a corresponding one of the pixel electrodes 34. This causes R, G, and B pixels to be defined. According to Embodiment 1, (i) one (1) pixel corresponds to a dotted area in FIG. 3, and (ii) one (1) picture element is made up of three pixels of the respective three colors RGB (see dashed-dotted area in FIG. 3).

Image signals are supplied, as data voltages, to the respective plurality of source lines 31 of the TFT liquid crystal panel 15 configured as above described. Note that each of the image signals has been subjected to data processing, through the line buffer section 11, the RGB reconfiguring section 12 (reconfiguring section), the data buffer section 13, and the timing control section 14 (see FIG. 1).

The line buffer section 11 is a buffer for temporarily storing RGB image data (input data signals) generated by an image processing circuit (not illustrated). The line buffer section 11 temporarily stores the input data signals such that data signals for respective adjacent pixels can be processed concurrently by the RGB reconfiguring section 12. The data signals are supplied to the RGB reconfiguring section 12 from the line buffer section 11.

The RGB reconfiguring section 12 (i) calculates a difference in data (tone) between respective pixels (target pixels) and respective adjacent pixels adjacent to the respective target pixels, (ii) reconfigures (reallocates), for each of the colors RGB, tones between respective identical-colored pixels such that a difference in tone between respective identical-colors becomes a smallest one, and (iii) supplies reconfigured data to the data buffer section 13. Note that the “target pixel” indicates an arbitrary pixel in the TFT liquid crystal panel 15. Also note that the “adjacent pixel” adjacent to the target pixel indicates a pixel connected, via a TFT element 33, with a source line 31 which will cause a foregoing feed-through pixel voltage to be generated in the target pixel.

“Data A” illustrated in FIG. 1 indicates example input data made up of image data corresponding to 12 pixels which are contained in an area. “Data B” illustrated in FIG. 1 indicates example data which has been subjected to reconfiguration by the RGB reconfiguring section 12. Note that the reconfiguration from Data A to Data B is illustrative only, and therefore Embodiment 1 is not limited to this reconfiguration.

Before sending data signals to the timing control section 14, the data buffer section 13 restores an order (timing) of the data signals.

The timing control section 14 sends the data signal, which has been received from the data buffer section 13, to the TFT liquid crystal panel 15 at a predetermined timing.

According to the liquid crystal display device 10 of Embodiment 1, the RGB reconfiguring section 12 carries out, for each of the three colors RGB, a process in which pieces of data (i.e., tones) are interchanged between adjacent pixels. This suppresses a color crosstalk.

(Data Processing Carried Out by RGB Reconfiguring Section 12)

The following description will discuss a concrete example of a data processing carried out by the RGB reconfiguring section 12.

In the data processing, an image display area containing all picture elements is divided into a plurality of areas each of which contains 4 picture elements (i.e., 12 pixels) of vertical 2 picture elements×horizontal 2 picture elements (i.e., vertical 2 pixels×horizontal 6 pixels). Each of the plurality of areas, obtained by dividing the image display area, is selected as one (1) area. The RGB reconfiguring section 12 carries out, for each of the plurality of areas, reconfiguration (reallocation) with respect to pixels contained in the one (1) area. FIG. 1 illustrates “Data A” as example input data made up of image data corresponding 12 pixels, which are contained in one of the plurality of areas.

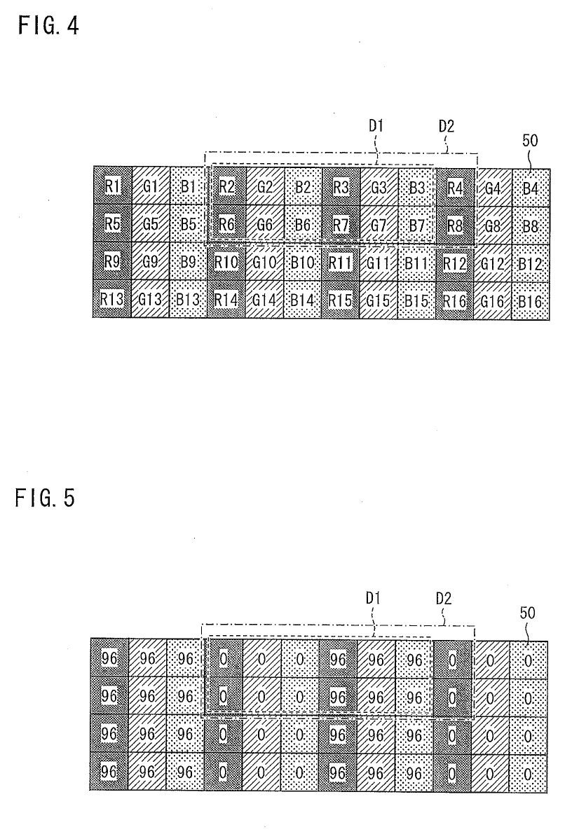

The following description will concretely discuss how image data is reconfigured. FIG. 4 is a view schematically illustrating a pixel array to be processed. In the pixel array illustrated in FIG. 4, “Rn” (here, “n” is an integer between 1 and 16) indicates a red pixel 50, “Gn” (here, “n” is an integer between 1 and 16) indicates a green pixel 50, and “Bn” (here, “n” is an integer between 1 and 16) indicates a blue pixel 50. Reference numerals 1 through 16 are assigned to the pixels in the picture elements from left to right and in descending order, i.e., R1, G1, and B1 belong to an upper left picture element and R16, G16, and B16 belong to a lower right picture element.

The following description will discuss how to reconfigure image data in an area D1. The area D1 is indicated by a dotted area in FIG. 4.

In a case of carrying out a reconfiguration process with respect to image data in the area D1, the RGB reconfiguring section 12 refers to data (tones) of pixels in an area D2 (see a dashed-dotted area in FIG. 4), which data is contained in the image data which has been received from the line buffer section 11.

First, a difference in data (tone) is calculated, for each of the colors RGB, between (i) the respective pixels (hereinafter, referred to as “target pixels”) in the area D1 and (ii) respective pixels (for convenience, hereinafter, referred to as “adjacent pixels”) which are connected with respective source lines which cause feed-through pixel voltages in the respective target pixels. Note that, according to Embodiment 1, the “adjacent pixel” is a target pixel's right-hand neighbor. Then, (i) an integrated value of the differences of red pixels is calculated, (ii) an integrated value of the differences of green pixels is calculated, and (iii) an integrated value of the differences of blue pixels is calculated.

In a case where (i) the integrated value of differences of the red pixels is indicated by “SR_m”, (ii) the integrated value of differences of the green pixels is indicated by “SG_m”, and (iii) the integrated value of the differences of blue pixels is indicated by “SB_m”, the integrated values SR_m, SG_m, and SB_m in the area D1 of FIG. 4 can be calculated in accordance with Formulae (A), (B), and (C) below, respectively. Note that, in each of Formulae (A), (B), and (C) below, “abs(x−y)” indicates an absolute value of a difference between “x” and “y”. Moreover, “Rp”, “Gp”, “Bp”, “Rq”, “Gq”, and “Bq” (each of “p” and “q” is an integer equal to or more than 1) indicate tones of respective pixels.

SR_{—}m=Σabs(Rp−Gq) Formula (A)

(“p” and “q” each indicate an arbitrary one of 2, 3, 6, and 7)

SG_{—}m=Σabs(Gp−Bq) Formula (B)

(“p” and “q” each indicate an arbitrary one of 2, 3, 6, and 7)

SB_{—}m=Σabs(Bp−Rq) Formula (C)

(“p” indicates an arbitrary one of 2, 3, 6, and 7 and “q” indicates an arbitrary one of 3, 4, 7, and 8)

Subsequently, a sum S of a difference between any two of the integrated values SR_m, SG_m, and SB_m is calculated in accordance with Formula (D) below.

S=abs(SR_{—}m−SG_{—}m)+abs(SR_{—}m−SB_{—}m)+abs(SG_{—}m−SB_{—}m) Formula (D)

The RGB reconfiguring section 12 extracts a combination of p and q which causes the sum S, calculated in accordance with Formula (D), to become smallest. The RGB reconfiguring section 12 then carries out a reconfiguration with respect to the pixel array in the area D1 based on an extracted combination of p and q.

(Concrete Example 1 of Data Processing)

The following description will discuss a case where the data processing method is applied to a concrete pixel array. Note that Concrete Example 1 is illustrative only, and therefore Embodiment 1 is not limited to Concrete Example 1.

FIG. 5 is a view illustrating an example of tones of the respective pixels arranged as illustrated in FIG. 4. In Concrete Example 1, the data processing is carried out with respect to pixels in the area D1 of the input image data, which pixels have respective tones as illustrated in FIG. 5.

The following integrated values SR_m, SG_m, and SB_m of the input image data in the area D1 are calculated in accordance with Formulae (A), (B), and (C).

$$\begin{matrix}SR\_m = abs ( R 2 - G 2 ) + abs ( R 3 - G 3 ) + abs ( R 6 - G 6 ) + \\ abs ( R 7 - G 7 ) \\ = abs ( 0 - 0 ) + abs ( 96 - 96 ) + abs ( 0 - 0 ) + abs ( 96 - 96 ) \\ = 0\end{matrix}$$

$$\begin{matrix}SG\_m = abs ( G 2 - B 2 ) + abs ( G 3 - B 3 ) + abs ( G 6 - B 6 ) + \\ abs ( G 7 - B 7 ) \\ = abs ( 0 - 0 ) + abs ( 96 - 96 ) + abs ( 0 - 0 ) + abs ( 96 - 96 ) \\ = 0\end{matrix}$$

$$\begin{matrix}SB\_m = abs ( B 2 - R 3 ) + abs ( B 3 - R 4 ) + abs ( B 6 - R 7 ) + \\ abs ( B 7 - R 8 ) \\ = abs ( 0 - 96 ) + abs ( 96 - 0 ) + abs ( 0 - 96 ) + abs ( 96 - 0 ) \\ = 384\end{matrix}$$

The following sum S of the integrated values SR_m, SG_m, and SB_m of the input image data in the area D1 is calculated in accordance with Formula (D).

S=abs(0−0)+abs(0−384)+abs(0−384)=0+384+384=768

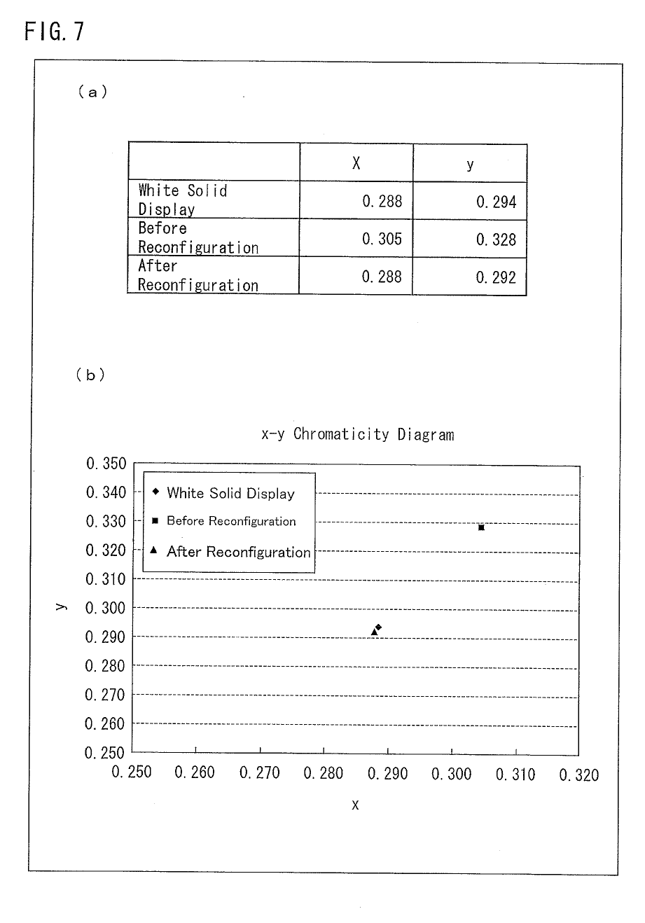

The sum S of the input image data is 768. The value 768 is large, and will therefore cause a color crosstalk (see (b) of FIG. 7). In order to prevent such a color crosstalk, the RGB reconfiguring section 12 carries out a reconfiguration with respect to the pixel array as follows.

Note that a calculation used to reconfigure the tones of the pixel array, which calculation will be described below, can be carried out by use of a conventional operation circuit (such as an FPGA). Alternatively, such a calculation can be carried out by use of a dedicated IC (an application specific integrated circuit (ASIC)).

First, integrated values SR_m, SG_m, and SB_m are calculated with respect to pixels in the area D1 by referring to data of pixels in the area D2, and then a sum S of a difference between any two of the integrated values SR_m, SG_m, and SB_m is calculated. Subsequently, a combination of the pixels is selected, which combination causes the sum S to become smallest.

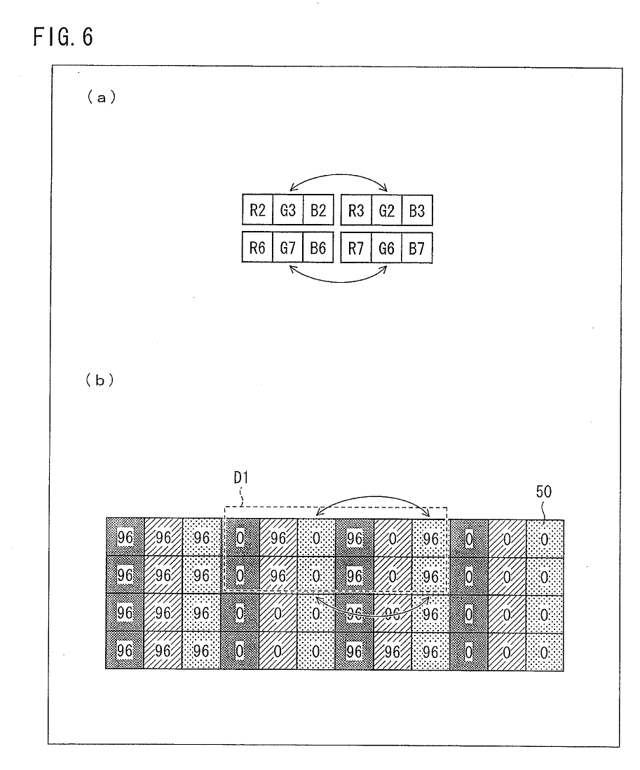

(a) of FIG. 6 illustrates a selected combination of pixels. (b) of FIG. 6 illustrates tones of the respective pixels, which tones have been subjected to a reconfiguration.

In the selected combination, G2 and G3 in the input image data have been interchanged, and G6 and G7 in the input image data have been interchanged (see (a) of FIG. 6). The tones of respective pixels in the input image data (Data A) are interchanged, by the RGB reconfiguring section 12, based on the selected combination. This causes output image data (Data B) to have tones of the respective pixels as illustrated in (b) of FIG. 6.

In a case where the pixels in the area D1 are arranged as illustrated in (b) of FIG. 6, integrated values SR_m, SG_m, and SB_m in the area D1 have identical values, i.e., SR_m=384, SG_m=384, and SB_m=384.

A sum S of the integrated values SR_m, SG_m, and SB_m is therefore calculated as follows:

S=0+0+0=0

That is, the sum S becomes a smallest value (=0).

By thus reconfiguring, as illustrated in (b) of FIG. 6, the pixel array in the area D1 of the input image data illustrated in FIG. 5, ratios of feed-through pixel voltages in the respective colors RGB become identical with each other.

Note that the description has merely discussed an example in which the data processing is carried out with respect to one (1) area, i.e., the area D1. By carrying out the data processing with respect to all the pixels in the display area, it is possible to prevent an entire panel from having a shift in chromaticity, and a color crosstalk can therefore be improved.

FIG. 7 shows x-y chromaticity obtained when the data processing is carried out with respect to all pixels in a display area of a TFT liquid crystal panel. FIG. 7 further shows, for comparison, (i) x-y chromaticity obtained by a white solid display (i.e., a display obtained when all the pixels of RGB have a highest tone (=a tone level of 96)) and (ii) x-y chromaticity of input image data which has not been subjected to a reconfiguration.

In the case of the input image data which has not been subjected to a reconfiguration (in which case white picture element vertical lines and black picture element vertical lines are alternately provided), both values x and y are larger than those of the white solid display (see (a) of FIG. 7). That is, the output chromaticity of the input image data which has not been subjected to a reconfiguration is shifted toward yellow side. On the other hand, in the case of the input image which has been subjected to a reconfiguration (i.e., the input image to which the data processing has been carried out by the RGB reconfiguring section 12), both values x and y and those of the white solid display are substantially similar to each other.

As is clear from a graph of (b) of FIG. 7, the chromaticity of the image data which has not been subjected to a reconfiguration is significantly changed as compared with that of the white solid display, whereas the chromaticity of the image data which has been subjected to a reconfiguration is slightly changed as compared to that of the white solid display.

Note that the “white solid display” indicates a display obtained when all the pixels have a highest tone, i.e., a tone level of 96.

As above described, the liquid crystal display device 10 of Embodiment 1 (i) calculates, for each of the colors RGB, a difference between (a) a tone of a pixel electrode connected with one of adjacent two source lines and (b) another tone of another electrode connected with the other of the adjacent two source lines and (ii) reconfigures tones such that the difference between the colors RGB becomes smaller than a difference which has not been reconfigured. With the configuration, it is possible to reduce a difference, between the colors RGB, in degree of occurrence of feed-through pixel voltages. This allows suppression of color crosstalk in a high definition and/or high resolution TFT liquid crystal panel.

(Concrete Example 2 of Data Processing)

As above described, it is possible to reduce color shift by reconfiguring image data with the use of the method discussed in Concrete Example 1. On the other hand, however, the reconfiguration of the pixel array in the area D1 sacrifices luminance resolution.

Under the circumstances, the following description will discuss Concrete Example 2 which employs a method for reducing a color crosstalk while suppressing a decrease in resolution. According to the method, tones of a pixel array are reconfigured in a manner similar to the method discussed in Concrete Example 1, except that no reconfiguration is carried out with respect to green pixels. This is based on the fact that green (G) of the colors RGB makes the largest contribution to luminance.

As with Concrete Example 1, Concrete Example 2 will discuss a case where data processing is carried out with respect to pixels in an area D1 of input image data, which pixels have respective tones as illustrated in FIG. 5. Note that such a case is illustrative only, and therefore Embodiment 1 is not limited to such a case.

In Concrete Example 2, integrated values SR_m, SG_m, and SB_m are calculated with respect to an area D1 of image data shown in FIG. 5, in a manner similar to that of Concrete Example 1, except that tones of respective green pixels are fixed. Then, a sum S of the integrated values SR_m, SG_m, and SB_m is calculated. Subsequently, a combination of tones of the respective pixels is selected, which combination causes the sum S to become a smallest value.

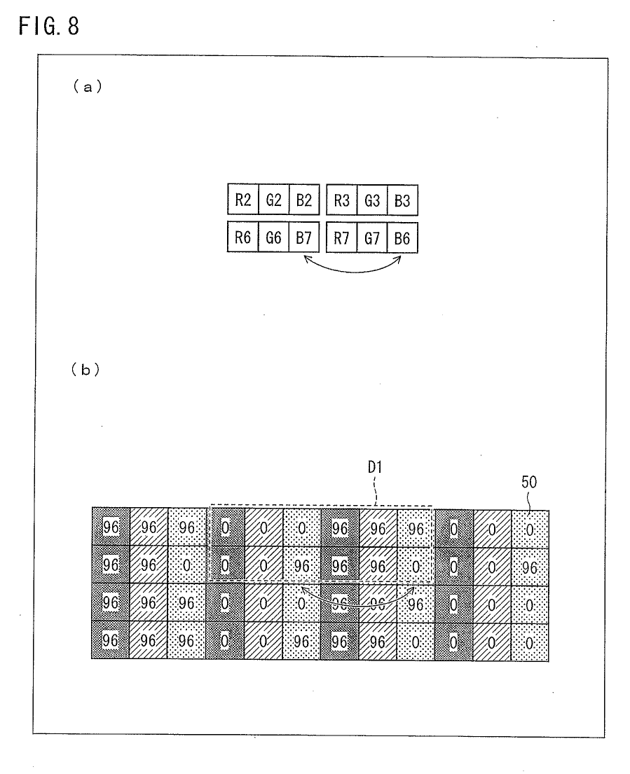

A result is shown in FIG. 8. (a) of FIG. 8 shows a selected combination of pixels. (b) of FIG. 8 shows the pixels whose tones have been reconfigured.

According to the selected combination, B6 and B7 in the input image data have been interchanged (see (a) of FIG. 8). The tones of respective pixels, in the input image data (Data A), are interchanged by the RGB reconfiguring section 12 based on the selected combination. This causes output image data (Data B) to have tones of the respective pixels as illustrated in (b) of FIG. 8.

In a case where the pixels in the area D1 are arranged as illustrated in (b) of FIG. 8, integrated values SR_m, SG_m, and SB_m in the area D1 are SR_m=0, SG_m=192, and SB_m=192, respectively.

A sum S of the integrated values SR_m, SG_m, and SB_m becomes therefore as follows:

S=192+192+0=384

The sum of 384 is a smallest one of combinations in which the tones of the green pixels are fixed, although the sum S (=384) is larger than that obtained in Concrete Example 1.

Note that the description has merely discussed an example in which the data processing is carried out with respect to one (1) area, i.e., the area D1. By carrying out the data processing with respect to all the pixels in the display area, it is possible to reduce a shift in chromaticity in an entire panel, and a color crosstalk can therefore be improved, while reducing deterioration in resolution.

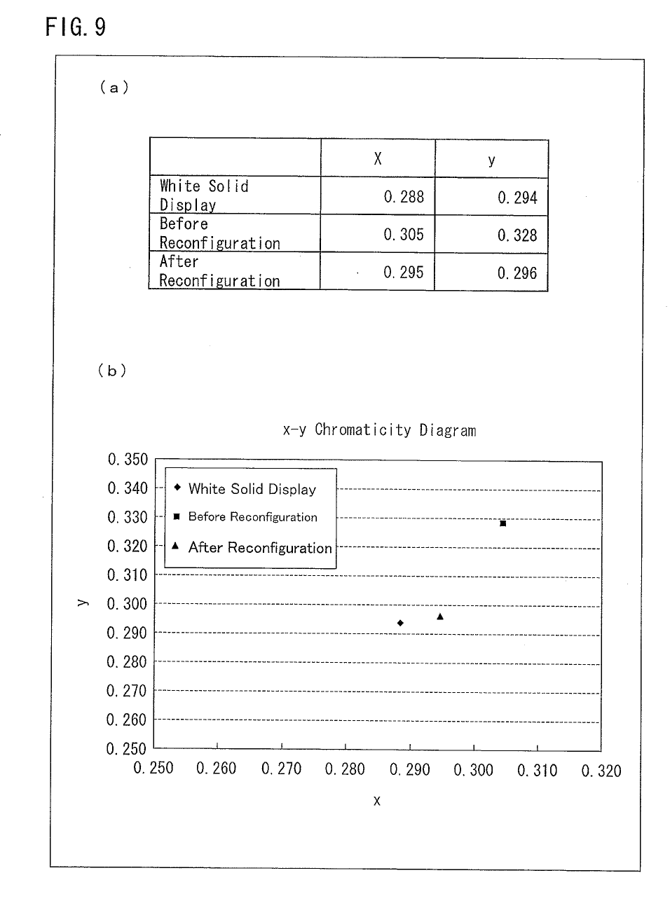

FIG. 9 shows x-y chromaticity obtained when the data processing of Concrete Example 2 is carried out with respect to all pixels in a display area of a TFT liquid crystal panel. FIG. 9 further shows, for comparison, (i) x-y chromaticity obtained by a white solid display (i.e., a display obtained when all the pixels of RGB have a highest tone (=a tone level of 96)) and (ii) x-y chromaticity of input image data which has not been subjected to a reconfiguration.

As is clear from a table shown in (a) of FIG. 9, a difference in values x and y between the image data that has been subjected to a reconfiguration and the white solid display can be made smaller than that between the image data that has not been subjected to a reconfiguration and the white solid display.

According to a result of the reconfiguration shown in a graph of (b) of FIG. 9, chromaticity of the image data, which has not been subjected to a reconfiguration, significantly changed as compared with that of the white solid display, whereas chromaticity of the image data, which has been subjected to a reconfiguration, slightly changed as compared to that of the white solid display.

According to the data processing, the tones of the respective green pixels in reconfigured image data are identical with those of the input image data. This makes it possible to suppress a decrease in resolution to the minimum. The following description will discuss a reason why the decrease in resolution can be suppressed by fixing the tones of the respective green pixels, which make the largest contribution to luminance.

Note that there occurs a difference in luminance between, for example, a red display with a tone level of 96 and a green display with a tone level of 96, even though the tone levels are thus identical with each other. A luminance ratio of red, green, and blue is standardized for each of various types of display. According to the standard of, for example, a high definition TV broadcasting, contributions of respective colors RGB to luminance are standardized based on a formula below.

Y=0.213R+0.715G+0.072B

In the formula, “Y” indicates a luminance signal, “R” indicates a red signal, “G” indicates a green signal, and “B” indicates a blue signal.

As is clear from the formula, green (G) makes the largest contribution to luminance. Under the circumstances, there are many videos in which luminance resolution of a picture element is determined based on green luminance, although it depends on colors to be displayed. A general display panel is therefore designed such that a green pixel is provided in a center of a picture element made up of three pixels of RGB.

For the reasons above, it is possible to reduce a deterioration in luminance resolution in a natural image display, by reconfiguring image data while fixing green pixels as described in Concrete Example 2.

(Principle of Present Invention)

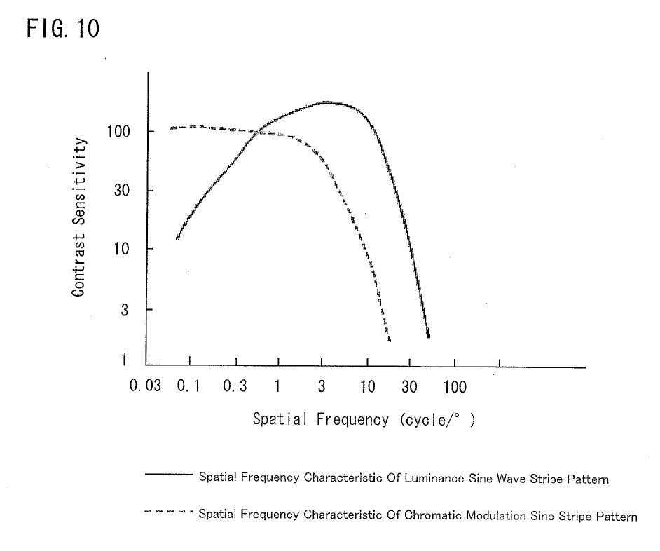

In recent years, high definition panels have been employed in large-screen televisions, in order to compatible with full high definition (FHD), which has become popular. Moreover, a display has been exhibited at an exhibition, etc., which display has a resolution of 4K2K (i.e., pixel number of 4096×2160), whose resolution is approximately four times higher than full high definition. Under the circumstances, it is anticipated that a higher definition will be continuously studied and developed. Moreover, it appears that high definition panels have been employed also in small-screen displays, as is seen in an example in which a WVGA panel is employed in a mobile phone. According to visual characteristics of human, a frequency characteristic of spatial resolution varies between luminance and chromaticity (see FIG. 10). Specifically, spatial resolution of chromaticity is known to be lower than that of luminance.

FIG. 10 is a graph illustrating a frequency characteristic of spatial resolution, which characteristic is one of visual characteristics of human. In short, the “frequency characteristic of spatial resolution” numerically indicates to what degree a human can recognize (i) a gap between respective two of a plurality of vertical lines displayed and (ii) a width of each of the plurality of vertical lines.

Specifically, in a case where (i) white and black lines are alternately arranged and (ii) widths of the respective white and black lines are changed, a frequency characteristic of spatial resolution of luminance indicates a highest resolution frequency (i.e., narrowest widths of the respective white and black lines) that a human can recognize. In a case where, for example, (i) red and green lines are alternately arranged and (ii) widths of the respective red and green lines are changed, a frequency characteristic of spatial resolution of chromaticity indicates a highest resolution frequency (i.e., narrowest widths of the respective red and green lines) a human can recognize.

According to the present invention, a color crosstalk is improved by making use of the visual characteristics of human.

According to a high definition panel, a combination of tones of respective of a target pixel and an adjacent pixel does not need to be identical with that of inputted image data, provided that a predetermined condition is met. That is, a combination of the target pixel and the adjacent pixel can be employed, according to which combination a color crosstalk is difficult to occur in a displayed image.

As above described, according to the visual characteristics of human with regard to a spatial resolution, luminance has a band-pass characteristic and chromaticity has a low-pass characteristic. According to the visual perception of human, luminance resolution can be recognized up to a frequency higher than that of chromaticity resolution (see FIG. 10).

Herein, the “high definition panel” indicates a panel having a resolution which is (i) lower than a frequency at which luminance can be identified but (ii) higher than a frequency at which chromaticity can be identified. Embodiment 1 assumes, in particular, that a high definition panel is employed which has human-recognizable spatial resolution of luminance, which is approximately four times higher than human-recognizable spatial resolution of chromaticity. According to such a high definition panel, in a case where, for example, a resolution of the high definition panel is substantially identical with human-recognizable spatial resolution of luminance, chromaticity is visually recognized by a human as an average of chromaticities of respective adjacent four picture elements. Under the circumstances, even in a case where tones of respective identical-colored pixels (having any of colors RGB) are reconfigured (between adjacent picture elements), a human cannot recognize such reconfiguration due to the human's spatial resolution characteristic of chromaticity.

A color crosstalk is caused when a balance (ratio) of RGB becomes different from that of an input signal (input tones) due to a feed-through pixel voltage which is caused by a source line. Here, the “balance of RGB” indicates a balance of difference in input tone data between the respective colors RGB. Note that the difference in input tone data is a difference between (i) input tone data of a pixel and (ii) input tone data of an adjacent pixel which is adjacent to the pixel. In a case of, for example, a red pixel, the difference in input tone data is a difference between a voltage (i.e., input tone data) applied to a source line connected with the red pixel and a voltage (i.e., input tone data) applied to a source line connected with a green pixel adjacent to the red pixel.

Under the circumstances, in a case where, for example, each of R, G, and B is a simple color output (e.g., in a case of RGB outputs illustrated in FIG. 24), chromaticity will never change. Moreover, a color crosstalk will never be caused in a case where the colors RGB have substantially identical degrees of occurrences of feed-through pixel voltages, each caused by a combination of a target pixel and an adjacent pixel.

According to Embodiment 1, in a case where RGB outputs (i.e., tones,) in an image display area which contains a plurality of pixels, contain (a) a first target pixel and a first adjacent pixel having respective similar tones and (b) a second target pixel and a second adjacent pixel having respective largely different tones, it is possible to suppress shift in chromaticity by reconfiguring the arrangement of the RGB outputs (i.e., tones).

(Another Configuration Example)

The following description will discuss another example configuration of Embodiment 1.

According to the configuration above described, the image display area containing all the picture elements is divided into a plurality of areas each of which contains 4 picture elements (i.e., 12 pixels) of vertical 2 picture elements×horizontal 2 picture elements (i.e., vertical 2 pixels×horizontal 6 pixels). Each of the plurality of areas, obtained by dividing the image display area, is selected as one (1) area. However, Embodiment 1 is not limited to such a configuration. For example, each divided area can contain 6 picture elements (i.e., 18 pixels), each of which contains 6 pixels, i.e., pixels R10, G10, B10, R11, G11, and B11, in addition to the 12 pixels in the area D1 illustrated in FIG. 4.

The number of pixels which can be contained in each of the plurality of areas depends on a pixel pitch. In a case where a pixel pitch is approximately 0.3 mm, the number of pixels contained in each of the plurality of areas is preferably 12, as illustrated in FIG. 4. On the other hand, in a case where a pixel pitch is approximately 0.2 mm, the number of the pixels can be increased to approximately 18, as above described. The number of the pixels is determined depending on resolving power of human eye. That is, each of the plurality of areas can be expanded to a degree to which a human cannot recognize a decrease in resolution.

Note that resolution which can be recognized by a human is determined also by a distance between the human and a monitor display section. The above described relation between the pixel pitch and the number of pixels in an area corresponds to a case where a distance between the human and the monitor display section is approximately set to 1 h to 1.5 h, where “h” indicates a longitudinal (vertical) length of the monitor display section.

Note that Embodiment 1 is applicable to a multiple-primary-color RGBY panel, which have yellow (Y) in addition to three primary colors RGB. FIG. 18 illustrates a pixel array of a TFT liquid crystal panel made up of RGBY (four colors) pixels 50. According to the pixel array illustrated in FIG. 18, one (1) picture element is made up of four RGBY pixels 50. Even in the multiple-primary-color RGBY panel, an image display area is divided into a plurality of areas including an area D1, and tones are reconfigured for each of the four colors in each of the plurality of areas by referring to an area (such as an area D2) in the image display area (see FIG. 18).

### Embodiment 2

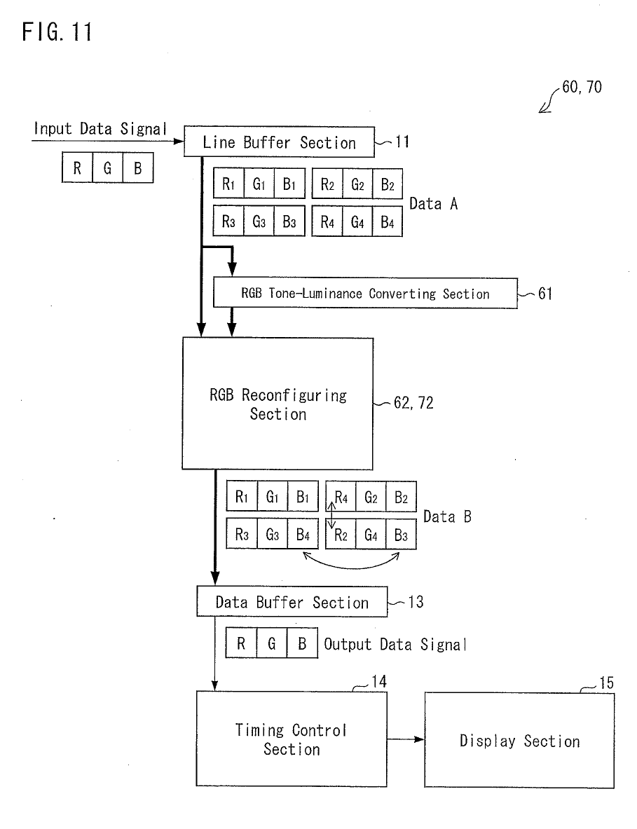

The following description will discuss Embodiment 2 of the present invention, with reference to FIGS. 11 through 14. Note that the present invention is not limited to Embodiment 2.

Embodiment 1 intends to improve a color crosstalk. On the other hand, Embodiment 2 intends to improve a change in luminance (i.e., a crosstalk) caused by a feed-through pixel voltage, and provides an intended display device. As an example of such a display device, the following description will discuss an active matrix color liquid crystal display device of Embodiment 2, which includes TFTs serving as switching elements and carries out a dot-reversal driving.

(Schematic Configuration of Liquid Crystal Display Device)

FIG. 11 illustrates a configuration of a liquid crystal display device 60 in accordance with Embodiment 2. The liquid crystal display device 60 mainly includes a line buffer section 11, an RGB tone-luminance converting section 61 (tone-luminance converting section), an RGB reconfiguring section 62, a data buffer section 13, a timing control section 14, and a TFT liquid crystal panel (display section) 15 (see FIG. 11).

Note that the TFT liquid crystal panel 15 of Embodiment 2 has a cross-sectional configuration and a planar configuration, which are identical with those illustrated in respective FIGS. 2 and 3 of Embodiment 1. Descriptions of the cross-sectional configuration and the planar configuration are therefore omitted here.

Image signals are supplied, as respective data voltages, to respective of a plurality of source lines 31 of the TFT liquid crystal panel 15. Note that each of the image signals has been subjected to data processing, through the line buffer section 11, the RGB reconfiguring section 12, the data buffer section 13, and the timing control section 14 (see FIG. 11).

The line buffer section 11 is a buffer for temporarily storing RGB image data (input data signals) generated by an image processing circuit (not illustrated). The line buffer section 11 temporarily stores the input data signals such that data signals for respective adjacent pixels can be processed concurrently by the RGB reconfiguring section 12. The data signals are supplied to the RGB reconfiguring section 12 from the line buffer section 11.

The RGB tone-luminance converting section 61 converts tones of the RGB image data into respective luminances. Data of luminances thus converted is supplied to the RGB reconfiguring section 62.

The RGB reconfiguring section 62 (i) fixes a tone of a pixel (target pixel) whose luminance is a highest one out of luminances of pixels in an area, based on the data of luminances supplied from the RGB tone-luminance converting section 61, (ii) calculates a difference in data (tone) between the target pixel and an adjacent pixel adjacent to the target pixel, (iii) reconfigures (reallocates) tones between respective identical-colored pixels (i.e., between red pixels, between green pixels, and between blue pixels) such that a difference in tone between respective identical-colors becomes a smallest one, and (iv) supplies reconfigured data to the data buffer section 13. Note that the “adjacent pixel” adjacent to the target pixel indicates a pixel connected, via a TFT, with a source line which will cause a foregoing feed-through pixel voltage to be generated in the target pixel.

“Data A” illustrated in FIG. 11 indicates example input data made up of image data corresponding to 12 pixels which are contained in an area. “Data B” illustrated in FIG. 11 indicates example data which has been subjected to reconfiguration by the RGB reconfiguring section 12. Note that the reconfiguration from Data A to Data B is illustrative only, and therefore Embodiment 2 is not limited to this reconfiguration.

Before sending data signals to the timing control section 14, the data buffer section 13 restores an order (timing) of the data signals.

The timing control section 14 sequentially sends each of the data signals, which have been received from the data buffer section 13, to the TFT liquid crystal panel 15 at a predetermined timing.

According to the liquid crystal display device 60 of Embodiment 2, the RGB reconfiguring section 62 (i) selects, as the target pixel, the pixel which has the highest luminance and (ii) carries out a process in which the difference in tone between the target pixel and the adjacent pixel becomes smaller. This causes a reduction in changed amount of luminance of image data obtained when crosstalk can occur with respect to image data obtained when no crosstalk occurs. This suppresses a crosstalk.

(Data Processing Carried Out by RGB Reconfiguring Section 62)

The following description will discuss a concrete example of a data processing carried out by the RGB tone-luminance converting section 61 and the RGB reconfiguring section 62.

In the data processing, an image display area containing all picture elements is divided into a plurality of areas each of which contains 4 picture elements (i.e., 12 pixels) of vertical 2 picture elements×horizontal 2 picture elements (i.e., vertical 2 pixels×horizontal 6 pixels). Each of the plurality of areas, obtained by dividing the image display area, is selected as one (1) area. The RGB reconfiguring section 62 carries out, for each of the plurality of areas, reconfiguration (reallocation) with respect to pixels contained in the one (1) area. FIG. 11 illustrates “Data A” as example input data made up of image data corresponding 12 pixels, which are contained in one of the plurality of areas.

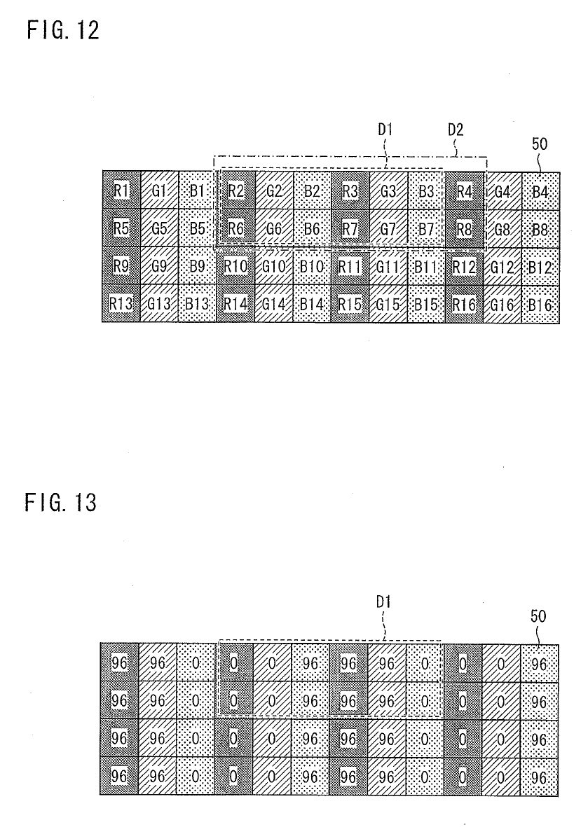

The following description will concretely discuss how image data is reconfigured. FIG. 12 schematically illustrates a pixel array to be processed. In the pixel array illustrated in FIG. 12, “Rn” (here, “n” is an integer between 1 and 16) indicates a red pixel 50, “Gn” (here, “n” is an integer between 1 and 16) indicates a green pixel 50, and “Bn” (here, “n” is an integer between 1 and 16) indicates a blue pixel 50. Reference numerals 1 through 16 are assigned to the pixels in the picture elements from left to right and in descending order, i.e., R1, G1, and B1 belong to an upper left picture element and R16, G16, and B16 belong to a lower right picture element.

The following description will discuss how to reconfigure image data in an area D1. The area D1 is indicated by a dotted area in FIG. 12.

In a case of carrying out a reconfiguration process with respect to image data in the area D1, the RGB reconfiguring section 62 refers to data (tones) of pixels in an area D2 (see dashed-dotted area in FIG. 12), which data is contained in the image data which has been received from the line buffer section 11.

In a case where the RGB reconfiguring section 62 reconfigures the image data, the RGB tone-luminance converting section 61 first calculates luminances of the respective pixels 50 contained in the area D1. In the case where the luminances of the respective pixels 50 in the area D1 are calculated, tones are converted into respective luminances for each of the colors RGB. This is because the colors RGB have respective different output luminances, even though the colors RGB have identical tones.

Specifically, in a case where (i) a luminance of a red pixel is indicated by “RTp”, (ii) a luminance of a green pixel is indicated by “GTp”, and (iii) a luminance of a blue pixel is indicated by “BTp”, the luminances RTp, GTp, and BTp in the area D1 of FIG. 12 can be calculated based on the following Formulae (E), (F), and (G). Note that, in each of the following Formulae (E), (F), and (G), “Lr(x)” indicates a conversion function for converting a tone x into a luminance of red, “Lg(x)” indicates a conversion function for converting the tone x into a luminance of green, and “Lb(x)” indicates a conversion function for converting the tone x into a luminance of blue. Moreover, each of “Rp”, “Gp”, and “Bp” (“p” is an integer equal to or more than 1) indicates a tone of a corresponding one of the pixels.

RTp=Lr(Rp) Formula (E)

(“p” indicates 2, 3, 6, or 7)

GTp=Lg(Gp) Formula (F)

(“p” indicates 2, 3, 6, or 7)

BTp=Lb(Bp) Formula (G)

(“p” indicates 2, 3, 6, or 7)

Note that the conversion functions Lr(x), Lg(x), and Lb(x) are respective different functions because the luminances vary depending on the colors RGB even though the colors RGB have identical tones.

In a case of, for example, a digital television broadcasting (HDTV) signal, a contribution ratio of each of the colors RGB to a luminance Y is expressed as the following Formula (H).

Y=0.213R+0.715G+0.072B Formula (H)

The conversion functions Lr(x), Lg(x), and Lb(x) are determined as follows based on Formula (H) for, for example, a display which is adjusted so as to have a γ value of 2.2.

Lr(x)=(L_max−L_{—}0)×0.213×(x/x_max)^{2.2}

Lg(x)=(L_max−L_{—}0)×0.715×(x/x_max)^{2.2}

Lb(x)=(L_max−L_{—}0)×0.072×(x/x_max)^{2.2}

Here, “L_max” indicates a highest luminance (i.e., luminance of white), “L_{—}0” indicates a lowest luminance (i.e., luminance of black), and “x_max” indicates a highest tone (e.g., a tone level of 255 in case of 8-bit). Note, however, that, in a case where a supplied signal is a TV signal, the tone x and the highest tone x_max fall within a range between 16 and 235 tones as Y signal (tone data value) (in case of 8-bit), due to the standard of the TV signal (that is, the tone level of 16 corresponds to black, and the tone level of 235 corresponds to white). In such a case, it is therefore necessary to convert a received Y signal into a tone x which is appropriate for the liquid crystal display device 60.

Alternatively, a luminance can be calculated for each of the colors RGB based on a tone by use of another method. That is, (i) an output characteristic of a display is measured in advance for each of the RGB, (ii) output values of the respective conversion functions Lr(x), Lg(x), and Lb(x) are obtained by subtracting lowest luminances (L_{—}0) from luminances in respective measured output characteristics and are then stored in a memory, and (iii) look-up tables (LUT) are prepared for the respective RGB.

That is, according to the method, (i) luminances for respective tones are measured in advance for each of the colors RGB and (ii) a look-up table (LUT) is prepared, for each of the colors RGB, in which the tones are associated with the respective luminances which have been obtained based on the respective tones. According to the method, luminances can be calculated based on respective tones with reference to the look-up tables of respective colors RGB stored in the memory of the liquid crystal display device 60.

The luminances RTp, GTp, and BTp thus obtained by the RGB tone-luminance converting section 61 are supplied to the RGB reconfiguring section 62 together with the tones Rp, Gp, and Bp.

The RGB reconfiguring section 62 selects a pixel having a highest one out of the luminances RTp, GTp, and BTp in the area D1. A selected pixel, which has the highest luminance, is left unchanged, and the selected pixel serves as a target pixel.

Subsequently, while referring to the tones Rp, Gp, and Bp of respective pixels in the area D2, the RGB reconfiguring section 62 calculates a difference in data (tone) between the target pixel and an adjacent pixel (which will cause a feed-through pixel voltage). Then, the RGB reconfiguring section 62 (i) reconfigures (reallocates) tones of the respective pixels in the area D1 for each of the colors RGB such that the difference in tone becomes zero or a smallest one and (ii) and supplies reconfigured data to the data buffer section 13.

(Concrete Example 1 of Data Processing)

The following description will discuss an example where the data processing method is applied to a concrete pixel array. Note that Concrete Example 1 is illustrative only, and Embodiment 2 is not limited to Concrete Example 1.

FIG. 13 illustrates an example of tones in a pixel array illustrated in FIG. 12. In this Concrete Example 1, the data processing is carried out with respect to an area D1 of the input image data with tones as illustrated in FIG. 13.

Note that the pixel array having the tones as illustrated in FIG. 13 can be also expressed as “blue tone level of 96—yellow tone level of 96”. This is because, when four picture elements are focused on in the area D1, left two picture elements are involved in a blue display, whereas right two picture elements are involved in a yellow (=red+green) display.

As a result of referring luminances obtained by the RGB tone-luminance converting section 61, it appears that pixels having a green tone level of 96 (i.e., the pixels G3 and G7) have a highest luminance in the area D1 of FIG. 13.

That is, the pixels G3 and G7 serve as respective target pixels, and their right-hand neighbors, i.e., the pixels B3 and B7 serve as respective adjacent pixels. The RGB reconfiguring section 62 reconfigures the tones of the respective pixels in the area D1 such that (i) a difference in tone between the pixels G3 and B3 and (ii) a difference in tone between the pixels G7 and B7 become respective smallest ones.

Specifically, the RGB reconfiguring section 62 selects a pixel Bp (in this case, “p” is 2, 3, 6, or 7), out of all the blue pixels (B2, B3, B6, and B7) contained in the area D1, which pixel Bp causes a difference abs(G3−Bp) and a difference abs(G7−Bp) to become respective smallest ones (in this case, the pixels B2 and B6 are selected as the pixel Bp). Then, (i) the pixels B2 and the pixel B3 are interchanged and (ii) the pixel B6 and the pixel B7 are interchanged by the RGB reconfiguring section 62.

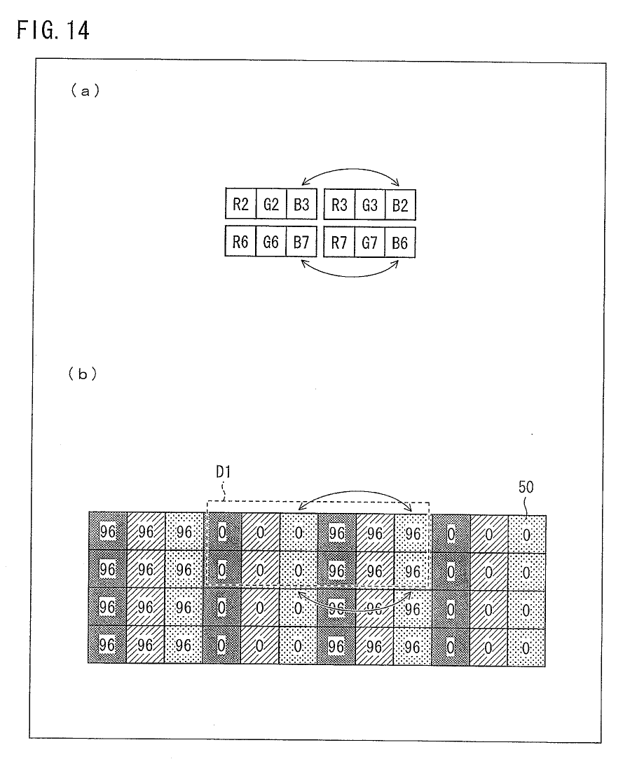

(a) of FIG. 14 illustrates a pixel array in which pixels have been interchanged. (b) of FIG. 14 illustrates tones of the respective pixels, which tones have been reconfigured.

In the pixel array, the pixels B2 and B3 in the input image data are interchanged, and the pixels B6 and B7 in the input image data are interchanged (see (a) of FIG. 14). Tones of respective pixels in the input image data (Data A) are interchanged, by the RGB reconfiguring section 62 interchanges, based on a selected combination. This causes output image data (Data B) to have tones of the respective pixels as illustrated in (b) of FIG. 14.

### Example

The following description will discuss an Example in which Embodiment 2 is applied to an actual TFT liquid crystal panel.

In a case where, for example, a TFT liquid crystal panel carries out a white solid display (in which all pixels of RGB have a highest tone, i.e., a tone level of 96), a luminance of the display becomes 27.2 cd/m². As such, in a case of a tone pattern as illustrated in FIG. 13, a luminance of the display ideally becomes 13.6 cd/m², which is half of the luminance of 27.2 cd/m², provided that no feed-through pixel voltage is caused by an adjacent source line.

However, in a case where the processing for the reconfiguration is not carried out (that is, in the case of the image data illustrated in FIG. 13, which has not been subjected to a reconfiguration), the luminance of the display becomes 11.7 cd/m², which is quite lower than the ideal luminance.

On the other hand, in a case where the processing for the reconfiguration is carried out with respect to all the pixels in the display area, a luminance of displayed image data that has been subjected to a reconfiguration becomes 13.3 cd/m², which is approximate to the ideal luminance.

This shows that the processing for the reconfiguration causes a slight variation from the luminance of the image data that has been subjected to a reconfiguration but can control such a variation to be small. The processing for the reconfiguration can further prevent a deterioration in spatial resolution of luminance in a case of general video picture. This is based on the following reason. Namely, a center of luminance of a picture element (i.e., a pixel which makes the largest contribution to luminance) is a green pixel, and a blue pixel contributes to luminance by approximately 1/10 of the green pixel. Therefore, even if two blue pixels are subjected to a reconfiguration so that their respective tones are interchanged, then it is presumed that such reconfiguration will have little impact on the spatial resolution of luminance.

The liquid crystal display device 60 of Embodiment 2 thus (i) does not change a tone of a first pixel electrode having a highest luminance and (ii) reconfigures tones such that a difference between (a) the tone of the first pixel electrode which is connected with one of adjacent two source lines (via a switching element) and (b) a tone of a second pixel electrode connected with the other of the adjacent two source lines, becomes smaller than a difference which has not been subjected to a reconfiguration.

According to the configuration, it is possible to reduce a changed amount of luminance of image data obtained when crosstalk can occur with respect to another image data obtained when no crosstalk occurs, by the simple method in which (i) the pixel having the highest luminance is set to be a target pixel and (ii) the difference in tone between the target pixel and the adjacent pixel is made smaller. This allows a reduction in changed amount of luminance in a high definition or high resolution TFT liquid crystal panel, and therefore an occurrence of crosstalk can be suppressed.

### Embodiment 3

The following description will discuss Embodiment 3 of the present invention, with reference to FIG. 11 and FIGS. 15 through 17. Note that the present invention is not limited to Embodiment 3.

Embodiment 2 intends to improve a change in chromaticity (color crosstalk), and Embodiment 1 intends to improve a change in luminance (color crosstalk). On the other hand, Embodiment 3 will describe a display device which is intended to improve both a change in chromaticity and a change in luminance. As an example of such a display device, Embodiment 3 will describe an active matrix color liquid crystal display device, which includes TFTs serving as switching elements and carries out a dot-reversal driving.

(Schematic Configuration of Liquid Crystal Display Device)

FIG. 11 illustrates a configuration of a liquid crystal display device 70 of Embodiment 3. The liquid crystal display device 70 mainly includes a line buffer section 11, an RGB tone-luminance converting section 61, an RGB reconfiguring section 72, a data buffer section 13, a timing control section 14, and a TFT liquid crystal panel (display section) 15 (see FIG. 11).

The liquid crystal display device 70 has a configuration basically identical with that of the liquid crystal display device 60 of Embodiment 2, except for the RGB reconfiguring section 72. Descriptions of such an identical configuration are therefore omitted here.

The RGB reconfiguring section 72 reconfigures tones of a pixel array in a manner similar to that of Embodiment 1, by taking into consideration (i) data of luminances of respective pixels 50, which data has received from the RGB tone-luminance converting section 61, (ii) data of luminances of respective picture elements 51, which data has received from the RGB tone-luminance converting section 61, and (iii) input image data (i.e., tones) received from the line buffer section 11. Specifically, the RGB reconfiguring section 72 (i) calculates a difference in data (tone) between respective target pixels and respective adjacent pixels adjacent to the respective target pixels and (ii) reconfigures, for each of the colors RGB, tones of the respective pixels such that the difference between the colors RGB becomes smaller than a difference which has not been reconfigured. Note that the “adjacent pixel” adjacent to the target pixel indicates a pixel connected, via a TFT, with a source line which will cause a foregoing feed-through pixel voltage in the target pixel.

According to the liquid crystal display device 70 of Embodiment 3, the RGB reconfiguring section 72 (i) calculates a difference in data (tone) between the respective target pixels and the respective adjacent pixels and (ii) reconfigures tones of the respective pixels such that (a) the difference between the colors RGB becomes smaller than a difference which has not been subjected to a reconfiguration, (b) luminances of the respective picture elements that have not been subjected to a reconfiguration are identical with those of the respective picture elements that have been subjected to the reconfiguration, and (c) chromaticity obtained by all the picture elements, in the area D1, that have not been subjected to a reconfiguration is identical with that obtained by all the picture elements, in the area D1, that have been subjected to the reconfiguration. This causes suppression of a change in luminance and a change in chromaticity.

(Data Processing Carried Out by RGB Reconfiguring Section 72)

The following description will discuss a concrete example of how a data processing is carried out by the RGB tone-luminance converting section 61 and the RGB reconfiguring section 72.

In the data processing, an image display area containing all picture elements is divided into a plurality of areas each of which contains 4 picture elements (i.e., 12 pixels) of vertical 2 picture elements×horizontal 2 picture elements (i.e., vertical 2 pixels×horizontal 6 pixels). Each of the plurality of areas, obtained by dividing the image display area, is selected as one (1) area. The RGB reconfiguring section 72 carries out a reconfiguration with respect to pixels contained in each of the plurality of areas. According to Embodiments 1 and 2, the reconfiguration is carried out by interchanging tones of the respective pixels in the four picture elements, instead of changing tones themselves of the respective pixels. On the other hand, according to Embodiment 3, a reconfiguration is carried out by changing an allocation (distribution) of luminances of respective pixels of RGB in four picture elements, instead of changing output luminances of the respective four picture elements.

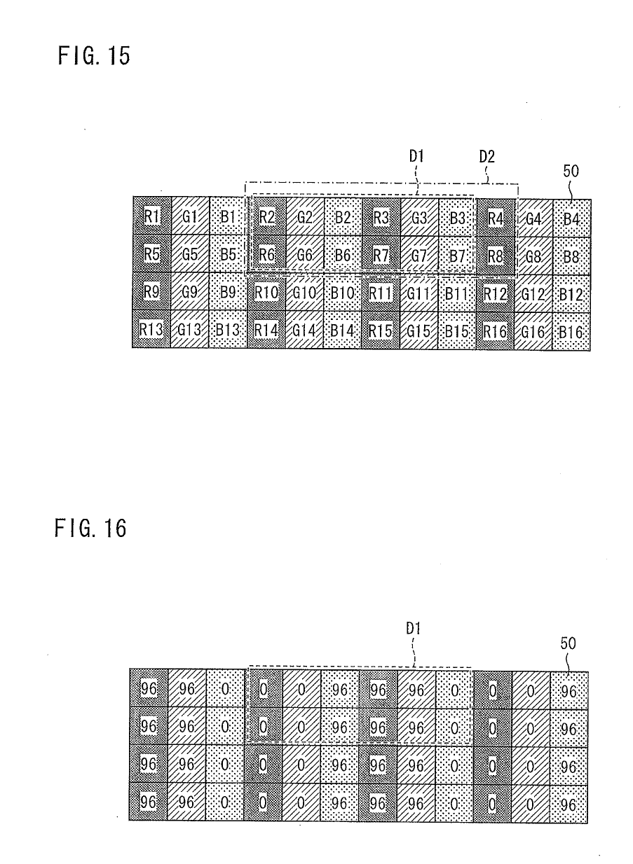

The following description will concretely discuss how image data is reconfigured. FIG. 15 schematically illustrates a pixel array to be processed. In the pixel array illustrated in FIG. 15, “Rn” (here, “n” is an integer between 1 and 16) indicates a red pixel 50, “Gn” (here, “n” is an integer between 1 and 16) indicates a green pixel 50, and “Bn” (here, “n” is an integer between 1 and 16) indicates a blue pixel 50. Reference numerals 1 through 16 are assigned to the pixels in the picture elements from left to right and in descending order, i.e., R1, G1, and B1 belong to an upper left picture element and R16, G16, and B16 belong to a lower right picture element.

The following description will discuss how to reconfigure image data in an area D1. The area D1 is indicated by a dotted area in FIG. 15.

In a case of carrying out a reconfiguration process with respect to image data in the area D1, the RGB reconfiguring section 72 refers to data (tones) of pixels in an area D2 (see dashed-dotted area in FIG. 15), which data is contained in the image data which has been received from the line buffer section 11.

When the RGB reconfiguring section 72 reconfigures the image data, the RGB tone-luminance converting section 61 first calculates luminances of the respective pixels 50 contained in the area D2. In the case where the luminances of the respective pixels 50 in the area D2 are calculated, tones are converted into respective luminances for each of the colors RGB. This is because the colors RGB have respective different output luminances, even though the colors RGB have identical tones. Note that Embodiment 3 can employ a method for converting tones into luminances for each of the colors RGB, which method is similar to that of Embodiment 2.

Specifically, in a case where (i) a luminance of a red pixel is indicated by “RTp”, (ii) a luminance of a green pixel is indicated by “GTp”, and (iii) a luminance of a blue pixel is indicated by “BTp”, the luminances RTp, GTp, and BTp in the area D2 of FIG. 15 can be calculated based on the following Formulae (E), (F), and (G). Note that, in each of the following Formulae (E), (F), and (G), “Lr(x)” indicates a conversion function for converting a tone x into a luminance of red, “Lg(x)” indicates a conversion function for converting a tone x into a luminance of green, and “Lb(x)” indicates a conversion function for converting a tone x into a luminance of blue. Moreover, each of “Rp”, “Gp”, and “Bp” (“p” is an integer equal to or more than 1) indicates a tone of a corresponding one of the pixels.

RTp=Lr(Rp) Formula (E)

(“p” indicates 2, 3, 6, 7, 4, or 8)

GTp=Lg(Gp) Formula (F)

(“p” indicates 2, 3, 6, or 7)

BTp=Lb(Bp) Formula (G)

(“p” indicates 2, 3, 6, or 7)

The luminances RTp, GTp, and BTp, which are thus obtained by the RGB tone-luminance converting section 61, are supplied to the RGB reconfiguring section 72 together with the tones Rp, Gp, and Bp.

The RGB reconfiguring section 72 reconfigures an allocation of output luminances of the respective pixels based on the data of luminances and the tones received from the RGB tone-luminance converting section 61. Specifically, in order to reduce a change in luminance and chromaticity while maintaining high resolution, the RGB reconfiguring section 72 carries out a reconfiguration such that (i) a luminance of four picture elements 51 (each of which is made up of three pixels of the respective colors RGB), contained in the area D1, is identical with a luminance of the four picture elements 51 that have been subjected to the reconfiguration and (ii) chromaticity of the four picture elements 51 that have not been subjected to the reconfiguration is identical to chromaticity of the four picture elements 51 that have been subjected to the reconfiguration.

Note that a luminance of a picture element 51 is determined by a total of luminances of respective three pixels 50 of RGB, which constitute the picture element 51. Specifically, a luminance of a picture element, made up of pixels R2, G2, and B2, can be obtained by (RT2+GT2+BT2).

In a case where (i) a luminance of a red pixel that has been subjected to a reconfiguration is indicated by “RTp′,” (ii) a luminance of a green pixel that has been subjected to the reconfiguration is indicated by “GTp′,” and (iii) a luminance of a blue pixel that has been subjected to the reconfiguration is indicated by “BTp′”, a condition, in which a luminance of the four picture elements 51, in the area D1, that have not been subjected to a reconfiguration is identical with a luminance of the four picture elements 51, in the area D1, that have been subjected to the reconfiguration, is expressed by Formulae (H-1) through (H-4) below.

RT2+GT2+BT2=RT2′+GT2′+BT2′ Formula (H-1)

RT3+GT3+BT3=RT3′+GT3′+BT3′ Formula (H-2)

RT6+GT6+BT6=RT6′+GT6′+BT6′ Formula (H-3)

RT7+GT7+BT7=RT7′+GT7′+BT7′ Formula (H-4)

A condition, in which chromaticity of the four picture elements 51, in the area D1, that have not been subjected to the reconfiguration is identical to chromaticity of the four picture elements 51, in the area D1, that have been subjected to the reconfiguration, is expressed by the following Formula (I).

$$RT 2 + RT 3 + RT 6 + RT 7 : GT 2 + GT 3 + GT 6 + GT 7 : BT 2 + BT 3 + BT 6 + BT 7 = RT {2}^{′} + RT {3}^{′} + RT {6}^{′} + RT {7}^{′} : GT {2}^{′} + GT {3}^{′} + GT {6}^{′} + GY {7}^{′} : BT {2}^{′} + BT {3}^{′} + BT {6}^{′} + BT {7}^{′} \qquad Formula ( I )$$

A difference in tone between respective target pixels and respective adjacent pixels is calculated based on the following Formula (J), where (i) a tone of a red pixel that has not been subjected to a reconfiguration is indicated by “Rp”, (ii) a tone of a green pixel that has not been subjected to the reconfiguration is indicated by “Gp”, and (iii) a tone of a blue pixel that has not been subjected to the reconfiguration is indicated by “Bp”. A reconfiguration of a pixel array is calculated such that an integrated value δD′ (obtained in accordance with Formula (K) below) of a difference in tone between respective target pixels and respective adjacent pixels, becomes a smallest one while Formulae (H-1) through (H-4) and (I) are being satisfied, where (i) a reconfigured tone of the red pixel is indicated by Rp′, (ii) a reconfigured tone of the green pixel is indicated by Gp′, and (iii) a reconfigured tone of the blue pixel is indicated by Bp′.

δD=|R2−G2|+|G2−B2|+|B2−R3|+|R3−G3|+|G3−B3|+|B3−R4|+|R6−G6|+|G6−B6|+|B6−R7|+|R7|G7|+|G7−B7|+|B7−R8| Formula (J)

δD′=|R2′−G2′|+|G2′−B2′|+|B2′−R3′|+|R3′−G3′|+|G3′−B3′|+|B3′−R4′|+|R6′−G6′|+|G6′−B6′|+|B6′−R7′|+|R7′−G7′|+|G7′−B7′|+|B7′−R8′| Formula (K)

Note, however, that, in a case where a difference in luminance, which has not been subjected to a reconfiguration, is equal to or less than 100 cd/m² between the four picture elements in the area D1 as later described in Concrete Example 1, the conditions of Formula (H-1) through (H-4) are not necessarily needed to be satisfied. In such a case, an allocation of tones to the respective pixels can be reconfigured, for each of the colors RGB, such that (i) the condition of Formula (I) is satisfied and (ii) the integration value δD′ becomes a smallest one.

Also note that various kinds of calculation methods can be employed as a method for determining an optimal reconfiguration of pixel array in accordance with the formulae above described, and Embodiment 3 can therefore employ any of such various kinds of calculation methods.

There are many methods for determining an optimal reconfiguration of pixel array. For example, the optimal reconfiguration of pixel array can be determined by repeatedly carrying out an arithmetic processing such as that made by a computer. A least-squares method can be employed as a most common method.

The least-squares method utilizes a fact that, in a case where the integration value δD′ obtained in accordance with Formula (K) becomes a smallest value, an integration square value δD′ obtained in accordance with Formula (L) below also becomes a smallest value.

δD′=(R2′−G2′)²+(G2′−B2′)²+(B2′−R3′)²+(R3′−G3′)²+(G3′−B3′)²+(B3′−R4′)²+(R6′−G6′)²+(G6′−B6′)²+(B6′−R7′)²+(R7′−G7′)²+(G7′−B7′)²+(B7′−R8′)² Formula (L)

When Formula (L) is expanded, square terms are obtained. Then, each value is partially differentiated, and the values become smallest ones when the partial differentiations become zero.

$$δ {D}^{′} / δ R {2}^{′} = 0$$

$$δ {D}^{′} / δ G {2}^{′} = 0$$

$$δ {D}^{′} / δ B {2}^{′} = 0$$

$$…$$

$$…$$

$$δ {D}^{′} / δ R {7}^{′} = 0$$

$$δ {D}^{′} / δ G {7}^{′} = 0$$

$$δ {D}^{′} / δ B {7}^{′} = 0$$

(the above equations are collectively referred to as “Formula (M)”)

By solving simultaneous equations of Formulae (L) and (M), the tones (Rp′, Gp′, and Bp′) can be obtained.

(Concrete Example 1 of Data Processing)

The following description will discuss a case where the data processing method above described is applied to a concrete example of a pixel array. Note that Concrete Example 1 is illustrative only, and Embodiment 3 is not limited to Concrete Example 1.

FIG. 16 illustrates an example of tones of the respective pixels arranged as illustrated in FIG. 15. In this Concrete Example 1, the data processing above described is carried out with respect to pixels in the area D1 of the input image data, which pixels have respective tones as illustrated in FIG. 16. Note that the pixel array having the tones as illustrated in FIG. 16 can be expressed as “blue tone level of 96—yellow tone level of 96”.

In the case of the tones as illustrated in FIG. 16, luminances of respective four picture elements, which are contained in an area D1 of a TFT liquid crystal panel, can be obtained, for example, in accordance with formulae below. In the formulae below, (i) “UL” indicates a luminance of an upper left picture element of the four picture elements, (ii) “UR” indicates a luminance of an upper right picture element of the four picture elements, (iii) “DL” indicates a luminance of a lower left picture element of the four picture elements, and (iv) “DR” indicates a luminance of a lower right picture element of the four picture elements.

UL=RT2+GT2+BT2=Lr(0)+Lg(0)+Lb(96)=4.3

UR=RT3+GT3+BT3=Lr(96)+Lg(96)+Lb(0)=23.0

DL=RT6+GT6+BT6=Lr(0)+Lg(0)+Lb(96)=4.3

DR=RT7+GT7+BT7=Lr(96)+Lg(96)+Lb(0)=23.0

A ratio of luminances RT, GT, and BT of all the four picture elements in the area D1 can be obtained as follows.

RT2+RT3+RT6+RT7=Lr(0)+Lr(96)+Lr(0)+Lr(96)=12.8

GT2+GT3+GT6+GT7=Lg(0)+Lg(96)+Lg(0)+Lg(96)=33.2

BT2+BT3+BT6+BT7=Lb(96)+Lb(0)+Lb(96)+Lb(0)=8.6

RT:GT:BT=(RT2+RT3+RT6+RT7):(GT2+GT3+GT6+GT7):(BT2+BT3+BT6+BT7)=12.8:33.2:8.6

In a case where (i) the luminances UL, UR, DL, and DR obtained as above are averaged and (ii) an allocation of tones to the respective pixels is reconfigured for each of the colors RGB, tones Rp′, Gp′, and Bp′ (here, “p” is 2, 3, 6, or 7) of the respective red, green, and blue pixels, included in the reconfigured four picture elements, can be obtained as follows.

Rp′=70

Gp′=69

Bp′=69

In the case where the red, green, and blue pixels have the respective tones above, the red, green, and blue pixels have the following luminances RTp′, GTp′, and BTp′ (here, “p” is 2, 3, 6, or 7), respectively.

RTp′=Lr(70)=3.2

GTp′=Lg(69)=8.3

BTp′=Lb(69)=2.2

In this case, an integration value δD′ of a difference between respective target pixels and respective adjacent pixels becomes as follows.

δD′=4

This value (i.e., 4) is a smallest one of values obtained by various combinations of the tones of the respective pixels in the area D1.

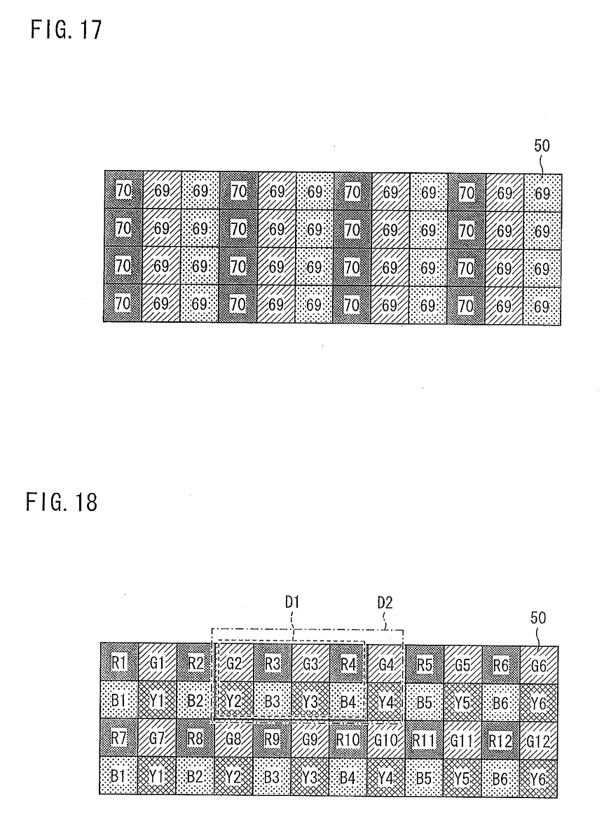

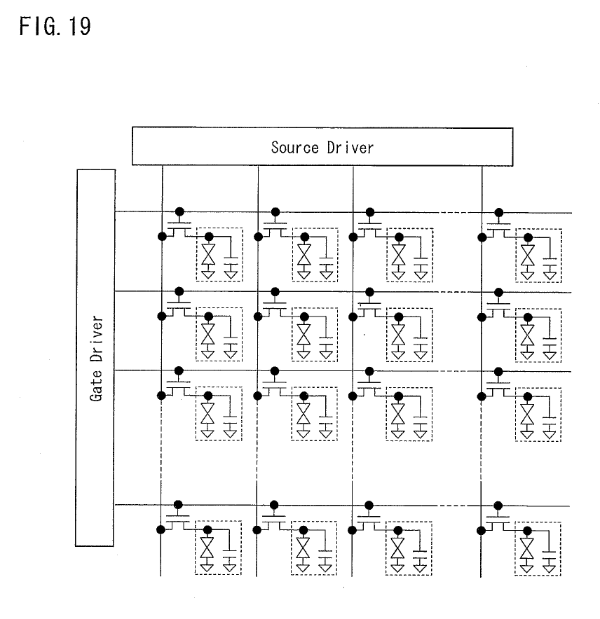

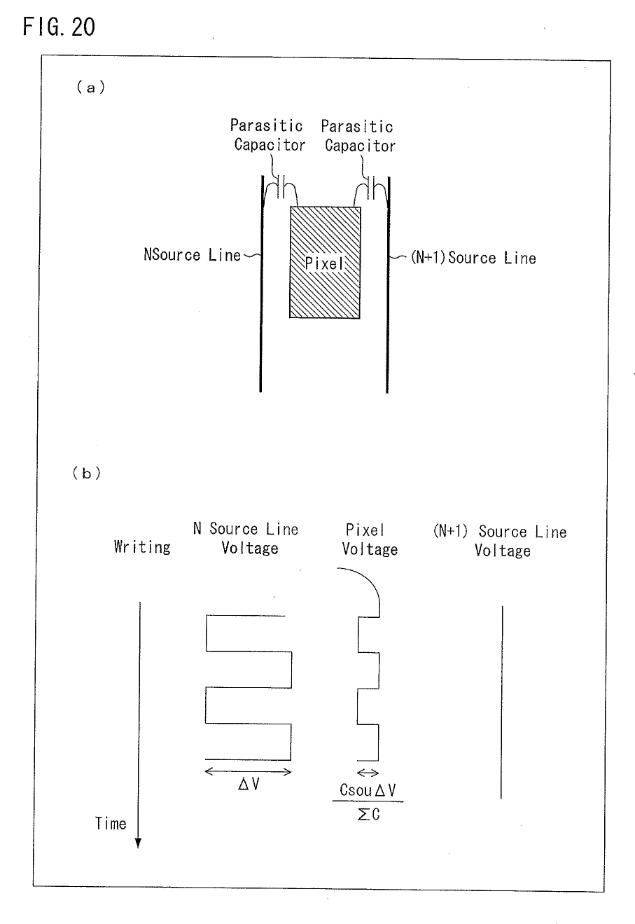

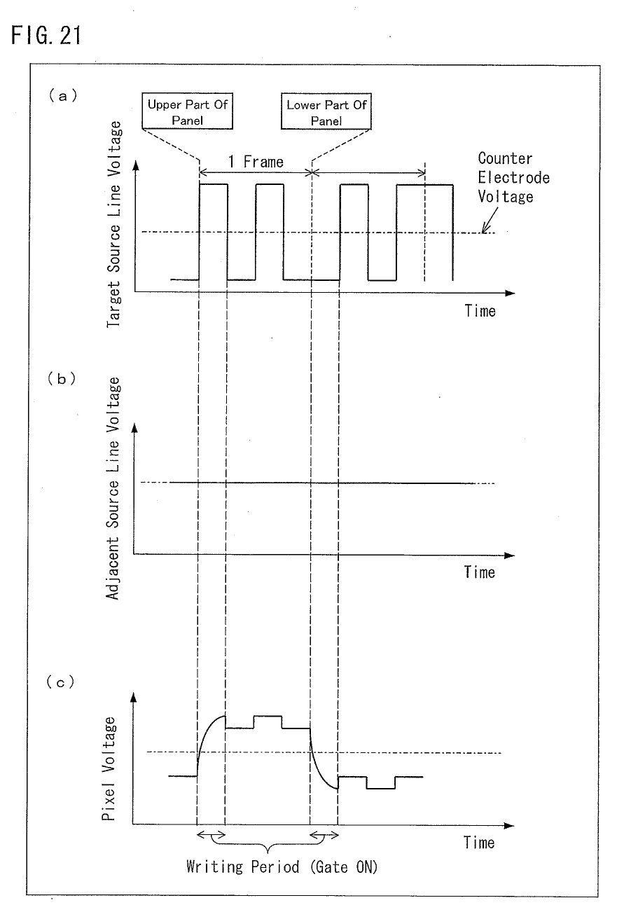

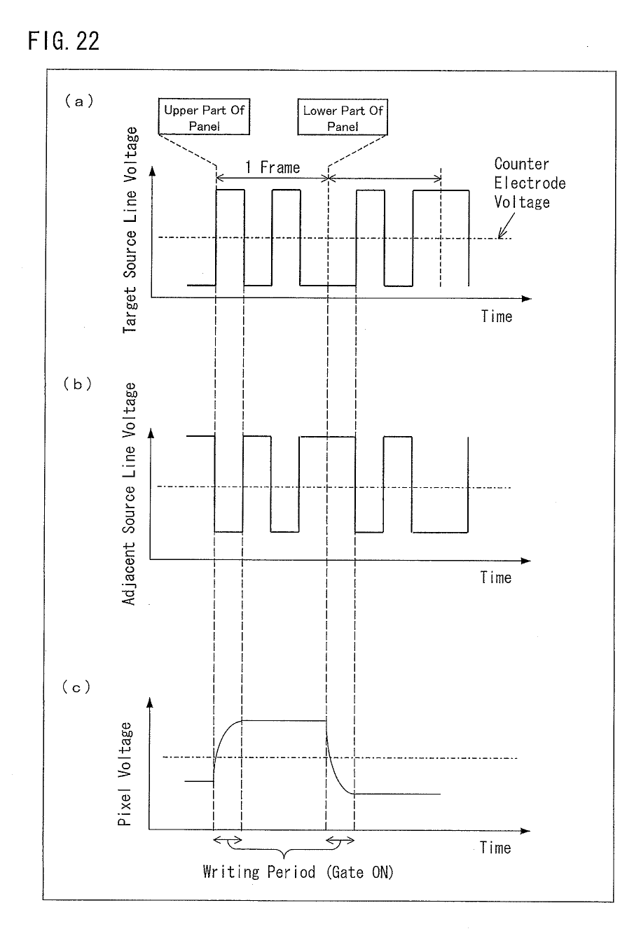

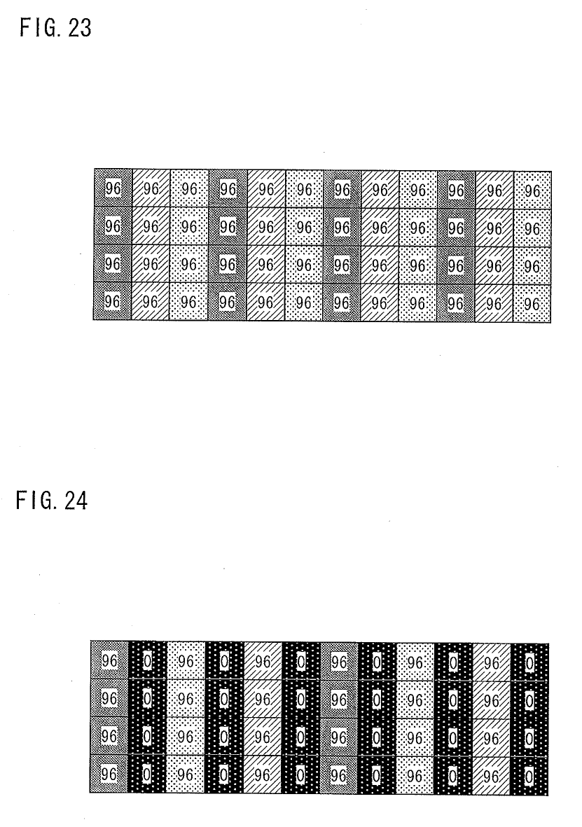

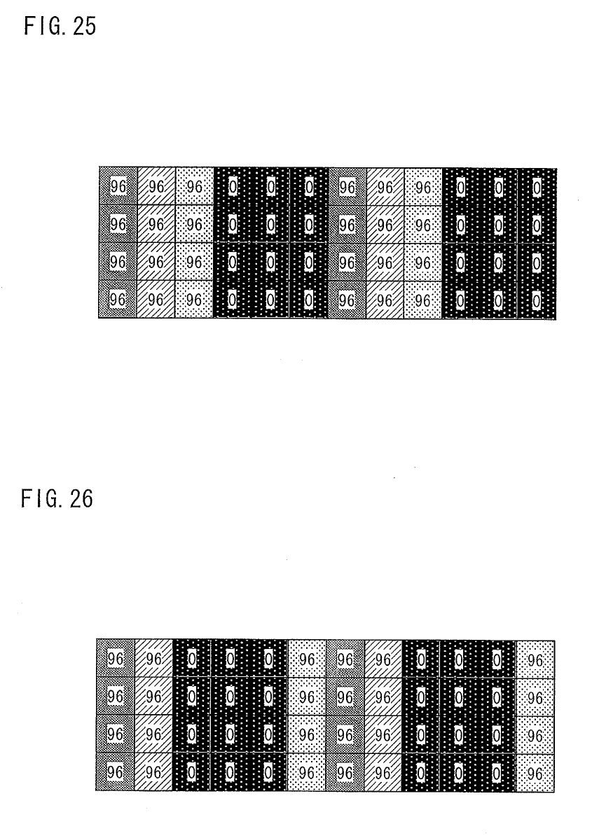

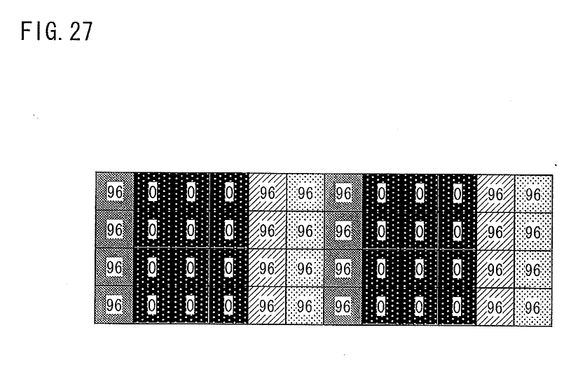

FIG. 17 illustrates tones of the respective pixels which tones have been subjected to a reconfiguration.

In the case where tones of the respective pixels in the area D1 are reconfigured as illustrated in FIG. 17, the conditions of Formulae (H-1) through (H-4) are not satisfied.

However, in the case illustrated in FIG. 17, a difference in luminance between respective adjacent two picture elements in the area D1 is equal to or less than 100 cd/m² (23.0-4.3<100). In a case (i) a high definition display panel has a picture element pitch of approximately 0.3 mm and a range of visibility of approximately 90 cm and (ii) the difference in luminance is equal to or less than 100 cd/m², it is difficult to recognize a difference in luminance between the respective adjacent two picture elements. Specifically, in a case where (a) gray lines each having a luminance of 100 cd/m² and (b) black lines each having a luminance of 0 cd/m² are displayed so as to be alternated, each of the gray lines and black lines is not recognized as a single line but is recognized as displaying gray of 50 cd/m².

Under the circumstances, a combination of tones, which causes the integration value δD′ to become a smallest one, can be obtained, as above described, by (i) averaging the luminances UL, UR, DL, and DR and (ii) reconfiguring the tones of the respective pixels in the area D1 for each of the colors RGB. This allows a suppression of a color crosstalk.

If the difference in luminance between the respective adjacent two picture elements is larger than 100 cd/m², then the following process is further carried out.

After the reconfiguration, the upper left picture element has, for example, the following luminance UL′.

UL′=RT2′+GT2′+BT2′=Lr(79)+Lg(69)+Lb(69)=12.7

The luminance UL′ (=12.7) is reduced to 4.3 in order to satisfy the condition of Formula (H-1). That is, an allocation of a luminance of the upper left picture element is reconfigured by moving a luminance of 8.4 cd/m² to the upper right picture element. Specifically, tones corresponding to the luminance 8.4 cd/m² are calculated, and tones of the upper left picture element are reduced by calculated tones. This causes the upper left picture element to have a reduction in the luminance by 8.4 cd/m². In this case, the integration value δD′ can be made smaller by changing, by identical tones, tones of the respective pixels of RGB in the upper left picture element. The process is thus carried out in which a combination of tones is found out which causes a reduction, by 8.4 cd/m², in the luminance of the upper left picture element by reducing, by identical tones, the tones of the respective pixels of RGB in the upper left picture element.

In a case of the luminance UR′ of the upper right picture element, the luminance UL′ (=12.7) is increased to 23.0 so that the condition of Formula (H-2) is satisfied. That is, an allocation of the luminance UL′ is reconfigured by moving a luminance of 10.3 cd/m² to the upper left picture element from the upper right picture element.

In summary, the RGB reconfiguring section 72 carries out an arithmetic processing in accordance with an algorithm below.

First, the luminances of the respective four picture elements are averaged so that a difference in tone data between respective adjacent two pixels is made smaller. This causes the difference in tone data between the respective adjacent two pixels to become a smallest one. Then, in a case where a difference in luminance between the respective adjacent two picture elements is larger than 100 cd/m², an allocation of luminances is reconfigured so that tones of the respective pixels of RGB are changed, by identical tones, in each of the adjacent two picture elements. This allows a difference in tone data between the respective adjacent two pixels to be a smallest one.

The arithmetic processing causes luminances to be allocated to the respective pixels in the area D1 as follows.

RT2′=Lr(51)=1.24

GT2′=Lg(51)=3.21

BT2′=Lb(51)=0.85

RT3′=Lr(79)=5.16

GT3′=Lg(78)=13.39

BT3′=Lb(78)=3.55

RT6′=Lr(51)=1.24

GT6′=Lg(51)=3.21

BT6′=Lb(51)=0.85

RT7′=Lr(79)=5.16

GT7′=Lg(78)=13.39

BT7′=Lb(78)=3.55

In this case, the integration value δD′ ultimately becomes 56, which is smaller than an integration value δD of 192 obtained before carrying out the reallocation.

Note that, instead of carrying out the arithmetic processing above described, tones can be reconfigured by carrying out an arithmetic processing in which simultaneous equations of Formulae (L) and (M) are solved.

As above described, based on visual characteristics of human, a change in chromaticity is minimized, without problems, by averaging the luminances of the respective four picture element. However, human's visibility with respect to a difference in luminance is higher than chromaticity. Under the circumstances, in a case where (i) a picture element pitch is 0.3 mm, (ii) a range of visibility is 90 cm, and (iii) a difference in luminance between respective adjacent two picture elements of four picture elements is equal to or larger than 100 cd/m² with a value corresponding to the luminance, such a difference in luminance can be recognized. It is therefore necessary to further carry out an allocation of luminances. In the case of the reconfigured tones illustrated in FIG. 17, the difference in luminance is smaller than 100 cd/m², and therefore no further reconfiguration is needed. If the difference in luminance is equal to or larger than 100 cd/m², then a reconfiguration is further carried out. In such a case, the reconfiguration can be carried out by utilizing the fact that tone data of green contributes to luminance more than each of tone data of red and tone data of blue.

### Example

The following description will discuss an Example in which Embodiment 3 is applied to an actual TFT liquid crystal panel.

In a case where, for example, a TFT liquid crystal panel carries out a white solid display (in which all pixels of RGB have a highest tone, i.e., a tone level of 96), a luminance of the white solid display becomes 27.2 cd/m². Under the circumstances, in a case where (i) a display is carried out with a tone pattern as illustrated in FIG. 16 and (ii) no feed-through pixel voltage is caused by an adjacent source line, it is ideal that a luminance of the display desirably becomes 13.6 cd/m², which is half of the luminance of 27.2 cd/m².

However, in a case where the data processing of Embodiment 3 is not carried out (that is, in the case of the image data illustrated in FIG. 16, which has not been subjected to a reconfiguration), the luminance of the display becomes 11.7 cd/m², which is largely lower than an ideal luminance.

On the other hand, in a case where the data processing of Embodiment 3 is carried out with respect to all the pixels in the display area, reconfigured image data is displayed with a luminance of 13.7 cd/m², which is approximate to the ideal luminance.

This clearly shows that the data processing of Embodiment 3 can suppress a change in luminance of the reconfigured image data (i.e., such a change is a small one) from the luminance of the image data which has not been subjected to the reconfiguration. In other words, it is clearly shown that the deviation in luminance from the ideal luminance, which difference is caused by a feed-through pixel voltage due to an adjacent source line, is sufficiently suppressed.

With regard to chromaticity, as compared to the white solid display having chromaticity of (x, y)=(0.288, 0.294), (i) the image data which has not been subjected to a reconfiguration has chromaticity of (x, y)=(0.262, 0.211) whereas (ii) the reconfigured image data has chromaticity of (x, y)=(0.282, 0.296). This shows that a color shift is also suppressed in the reconfigured image data.

Embodiment 3 is configured so that both a color crosstalk and a crosstalk are improved by making smaller a deviation in chromaticity and a deviation in luminance from the respective ideal chromaticity and luminance, whereas (i) Embodiment 1 is configured so that a color crosstalk is improved by reducing a deviation in chromaticity from the desired chromaticity and (ii) Embodiment 2 in which a crosstalk is improved by reducing a deviation in luminance from the ideal luminance.

Moreover, Embodiment 3 is configured so that an allocation of output luminances is reconfigured in the four picture elements 51 contained in the area D1, whereas Embodiments 1 and 2 are configured so that an arrangement of data (tones) of the pixels in the area D1, containing the four picture elements 51, are reconfigured for each of the colors RGB.

Namely, Embodiment 3 is configured so that a feed-through pixel voltage (i.e., a feed-through voltage caused by a capacity coupling of a pixel electrode and a source line), which causes a color crosstalk, is minimized by changing the luminances of the respective pixels of RGB in each of the four picture elements without changing output luminances of the respective four picture elements in the area D1.

The present invention is not limited to the embodiments, but can be altered by a skilled person in the art within the scope of the claims. Technical means altered within the scope of the claims or a proper combination of technical means disclosed in respective different embodiments is also encompassed in the technical scope of the present invention.

In order to attain the object, a display device of the present invention includes an active matrix substrate, the active matrix substrate including: a plurality of gate lines; a plurality of source lines provided so as to intersect with the plurality of gate lines; a first plurality of pixel electrodes each of which is provided (i) between corresponding adjacent two of the plurality of source lines and (ii) between corresponding adjacent two of the plurality of gate lines, each of the first plurality of pixel electrodes being provided for a color of a plurality of colors with which an image is to be constituted; and a plurality of switching elements provided in the vicinity of respective intersections of the plurality of gate lines and the plurality of source lines, each of the plurality of switching elements being connected with a corresponding one of the plurality of gate lines and a corresponding one of the plurality of source lines, each of the first plurality of pixel electrodes causing image to be displayed in accordance with a transmittance corresponding to a predetermined tone by electrically connecting (i) the corresponding one of the plurality of source lines which is connected to a corresponding one of the plurality of switching elements with (ii) the each of the first plurality of pixel electrodes when a scanning signal, indicative of instructions on electrical conduction, is supplied to the corresponding one of the plurality of gate lines connected to the corresponding one of the plurality of switching elements, the display device further including: a reconfiguring section for reconfiguring the tones between respective identical-colored ones of a second plurality of pixel electrodes in each of a plurality of areas into which a display area of the display device is divided, each of the plurality of areas containing the second plurality of pixel electrodes included in the first plurality of pixel electrodes, the reconfiguring section (i) calculating a first difference between (a) a first tone of a first pixel electrode, which is provided between corresponding adjacent two of the plurality of source lines and is connected with one of the corresponding adjacent two of the plurality of source lines and (b) a second tone of a second pixel electrode connected with the other of the corresponding adjacent two of the plurality of source lines and (ii) reconfiguring tones of the respective second plurality of pixel electrodes such that the first difference becomes smaller than a first difference which has not been reconfigured.

In order to attain the object, a method for driving a display device of the present invention is a method for driving a display device which includes an active matrix substrate, the active matrix substrate including: a plurality of gate lines; a plurality of source lines provided so as to intersect with the plurality of gate lines; a first plurality of pixel electrodes each of which is provided (i) between corresponding adjacent two of the plurality of source lines and (ii) between corresponding adjacent two of the plurality of gate lines, each of the first plurality of pixel electrodes being provided for a color of a plurality of colors with which an image is to be constituted; and a plurality of switching elements provided in the vicinity of respective intersections of the plurality of gate lines and the plurality of source lines, each of the plurality of switching elements being connected with a corresponding one of the plurality of gate lines and a corresponding one of the plurality of source lines, each of the first plurality of pixel electrodes causing image to be displayed in accordance with a transmittance corresponding to a predetermined tone by electrically connecting (i) the corresponding one of the plurality of source lines which is connected to a corresponding one of the plurality of switching elements with (ii) the each of the first plurality of pixel electrodes when a scanning signal, indicative of instructions on electrical conduction, is supplied to the corresponding one of the plurality of gate lines connected to the corresponding one of the plurality of switching elements, the method including the steps of: (i) dividing a display area of the display device into a plurality of areas, each of which contains a second plurality of pixel electrodes included in the first plurality of pixel electrodes; (ii) calculating a first difference between (a) a first tone of a first pixel electrode, which is provided between corresponding adjacent two of the plurality of source lines and is connected with one of the corresponding adjacent two of the plurality of source lines and (b) a second tone of a second pixel electrode connected with the other of the corresponding adjacent two of the plurality of source lines; and (iii) reconfiguring the tones between respective identical-colored ones of the second plurality of pixel electrodes in each of the plurality of areas such that the first difference becomes smaller than a first difference which has not been reconfigured.

Here, “reconfiguring the tones between respective identical-colored ones of the second plurality of pixel electrodes in each of the plurality of areas” means (i) to interchange tones between the identical-colored ones of the second plurality of pixel electrodes in each of the plurality of areas or (ii) to change, by the reconfiguration, an allocation of tones to the respective identical-colored ones of the second plurality of pixel electrodes without changing a luminance obtained by all the identical-colored ones of the second plurality of pixel electrodes in each of the plurality of areas.

According to the configuration or the method, (i) the first difference is calculated between (a) the first tone of the first pixel electrode, which is connected with one of the corresponding adjacent two of the plurality of source lines and (b) the second tone of the second pixel electrode connected with the other of the corresponding adjacent two of the plurality of source lines and (ii) the tones are reconfigured such that the first difference becomes smaller than a first difference which has not been reconfigured. With the configuration, it is possible to reduce a phenomenon called “feed-through pixel voltage”, in which phenomenon a voltage of the first pixel electrode is changed by a parasitic capacitor caused between the voltage of the first pixel electrode and a voltage of the other of the corresponding adjacent two of the plurality of source lines. This makes it possible to suppress a crosstalk.

According to the configuration or the method, a crosstalk is suppressed by carrying out the reconfiguration of the tones of the respective pixel electrodes by the method above described. It is therefore possible to carry out the data processing by an operation simpler than that employed in a conventional method.

According to the configuration or the method of the present invention, it is possible to suppress a crosstalk without carrying out a complicated correction calculation.

According to the display device of the present invention, it is preferable that the reconfiguring section calculates, for each of the plurality of colors, a second difference between the first and second tones; and the reconfiguring section reconfigures the tones of the respective second plurality of pixel electrodes such that the second difference between the plurality of colors becomes smaller than a second difference which has not been reconfigured.

According to the method of the present invention, it is preferable that, in the step (iii), the tones of the respective second plurality of pixel electrodes are reconfigured based on a second difference between the first and second tones calculated for each of the plurality of colors; and the reconfiguration is carried out such that the second difference between the plurality of colors becomes smaller than a second difference which has not been reconfigured.

According to the configuration or the method, the second difference between the first and second tones is calculated for each of the plurality of colors, and the tones of the respective second plurality of pixel electrodes are reconfigured such that the second difference between the plurality of colors becomes smaller than a second difference which has not been reconfigured. With the configuration, it is possible to reduce a difference, between the plurality of colors, in frequency of an occurrence of a feed-through pixel voltage. This causes image data, in which a color crosstalk can be caused, to have chromaticity closer to that of another image data in which no color crosstalk is caused. This allows suppression of a color crosstalk.

According to the configuration or the method, a color crosstalk can be suppressed by a simple method, in which a difference in tone is made smaller between the target pixel and the adjacent pixel by changing an allocation of tones in an area containing a plurality of pixels, instead of a method in which correction value data, which has been obtained by carrying out a complicated correction calculation, is outputted. Note that the method of the present invention, in which the allocation of tones is changed in the area containing the plurality of pixels, is preferably applicable to a high definition and high resolution display panel.

This is because, according to the visual characteristics of human, spatial resolution of luminance is different from spatial resolution of chromaticity. That is, the spatial resolution of luminance falls within a spatial frequency range higher than that of the spatial resolution of chromaticity. More specifically, sensitivity of luminance is a band-pass filter, and sensitivity of chromaticity is a low-pass filter (see FIG. 10).

Note that the high definition panel falls under a panel which has resolution (i) lower than a visual characteristic of luminance and (ii) higher than a visual characteristic of chromaticity. According to the present invention, reconfiguration of tones of respective pixels is carried out with respect to, in particular, such a high definition panel. This allows an improvement in color crosstalk, while a decrease in spatial resolution of chromaticity is not visually recognized by a human.

In the display device of the present invention, it is preferable that the reconfiguring section reconfigures combinations of tones of the respective second plurality of pixel electrodes such that the second difference between the plurality of colors becomes a smallest one.

According to the configuration, a difference in frequency of occurrence of feed-through pixel voltage can be made smaller between the plurality of colors. This makes it possible to surely suppress a color crosstalk.

In the display device of the present invention, it is preferable that the plurality of colors are red, green, and blue; and the reconfiguring section reconfigures only tones of respective of red pixel electrodes and blue pixel electrodes of the second plurality of pixel electrodes such that the second difference between the red, green, and blue becomes smaller than a second difference that has not been reconfigured.

According to the configuration, reconfiguration of tones is not carried out with respect to the green pixels which mostly contribute to luminance. This suppresses a decrease in resolution which can be caused by the reconfiguration of tones.

It is preferable that the display device of the present invention further includes a tone-luminance converting section for estimating, for each of the plurality of colors, a luminance based on pieces of data indicative of respective tones, which pieces of data are supplied to the respective first plurality of pixel electrodes, the reconfiguring section selecting a pixel electrode having a highest one of luminances, estimated by the tone-luminance converting section, out of the second plurality of pixel electrodes, and the reconfiguring section reconfiguring tones of the respective second plurality of pixel electrodes, while fixing a tone of a selected pixel electrode, such that a third difference between (i) the tone of the selected pixel electrode which is (a) provided between adjacent two of the plurality of source lines and (b) connected with one of the adjacent two of the plurality of source lines and (ii) a tone of a pixel electrode connected with the other of the adjacent two of the plurality of source lines, becomes smaller than a third difference that has not been reconfigured.

It is preferable that the method of the present invention further includes the step of: (iv) estimating, for each of the plurality of colors, a luminance based on pieces of data indicative of respective tones, which pieces of data are supplied to the respective first plurality of pixel electrodes, wherein, in the step (iii), a pixel electrode having a highest one of luminances, estimated in the step (iv), is selected out of the second plurality of pixel electrodes, and tones of the respective second plurality of pixel electrodes are reconfigured, while fixing a tone of a selected pixel electrode, such that a third difference between (a) the tone of the selected pixel electrode which is provided between adjacent two of the plurality of source lines and is connected with one of the adjacent two of the plurality of source lines and (b) a tone of a pixel electrode connected with the other of the adjacent two of the plurality of source lines, becomes smaller than a third difference that has not been reconfigured.

According to the configuration or the method, the reconfiguration of the tones is carried out, while fixing the tone of the selected pixel electrode having the highest luminance, such that the third difference between (a) the tone of the selected pixel electrode and (b) the tone of the pixel electrode connected with the other of the adjacent two of the plurality of source lines (i.e., a source line which is not connected with the selected pixel electrode via a switching element), becomes smaller than a third difference that has not been reconfigured.

With the configuration or the method, it is possible to causes image data, in which a crosstalk can be caused, to have a luminance closer to that of another image data in which no crosstalk is caused, by the simple method in which (i) the pixel having the highest luminance is set to be a target pixel and (ii) the difference in tone between the target pixel and the adjacent pixel is made smaller. This makes it possible to suppress a crosstalk.

In the display device of the present invention, it is preferable that the reconfiguring section reconfigures combinations of tones of the respective second plurality of pixel electrodes such that the third difference becomes a smallest one.

According to the configuration, a frequency of occurrence of a feed-through pixel voltage can be reduced in the selected pixel electrode having the highest luminance. This makes it possible to surely suppress a crosstalk.

In the display device of the present invention, it is preferable that the tone-luminance converting section calculates the luminance with reference to a look-up table in which tones are associated with respective output luminances for each of the plurality of colors.

According to the configuration, the luminance is calculated with reference to the look-up table. This makes it possible to easily calculate a luminance without carrying out a complicated operation.

In the display device of the present invention, it is preferable that the reconfiguring section reconfigures the tones of the respective second plurality of pixel electrodes such that (i) a luminance of a picture element is not changed even after the reconfiguration and (ii) chromaticity obtained by all picture elements in the each of the plurality of areas is not changed even after the reconfiguration.

In the method of the present invention, it is preferable that, in the step (iii), the tones of the respective second plurality of pixel electrodes are reconfigured such that (a) a luminance of a picture element is not changed even after the reconfiguration and (b) chromaticity obtained by all picture elements in the each of the plurality of areas is not changed even after the reconfiguration.

According to the configuration or the method, the reconfiguration of the tones is carried out by changing luminances of the respective pixels constituting the picture elements in the each of the plurality of areas without changing the output luminances of the respective picture elements such that a feed-through pixel voltage (i.e., a feed-through voltage caused by a capacity coupling with a source line), which causes a color crosstalk, can be reduced. With the configuration or the method, it is possible to improve a color crosstalk and a crosstalk by reducing a difference in chromaticity and a difference in luminance from the respective desired chromaticity and luminance.

In the display device of the present invention, it is preferable that in a case where a difference in luminance between respective adjacent two picture elements in the each of the plurality of areas is not larger than a predetermined difference, the reconfiguring section reconfigures tones of the respective second plurality of pixel electrodes by (i) averaging luminances of respective picture elements in the each of the plurality of areas and (ii) allocating tones to respective pixel electrodes, for each of the plurality of colors, such that chromaticity obtained by all the picture elements in the each of the plurality of areas is not changed even after the reconfiguration; and in a case where the difference in luminance between the respective adjacent two picture elements in each of the plurality of areas is larger than the predetermined difference, the reconfiguring section reconfigures the tones of the respective second plurality of pixel electrodes by (i) averaging luminances of the respective picture elements in the each of the plurality of areas, (ii) allocating tones to respective pixel electrodes, for each of the plurality of colors, such that chromaticity obtained by all the picture elements in the each of the plurality of areas is not changed even after the reconfiguration, and then (iii) reallocating luminances of the respective adjacent two picture elements by changing tones, by identical tones, of respective pixel electrodes, which are included in each of the adjacent two picture elements and have respective different colors of the plurality of colors, such that the luminances of the respective adjacent two picture elements are not changed even after the reconfiguration.

In the method of the present invention, it is preferable that, in the step (iii), in a case where a difference in luminance between respective adjacent two picture elements in the each of the plurality of areas is not larger than a predetermined difference, tones of the respective second plurality of pixel electrodes are reconfigured by (a) averaging luminances of respective picture elements in the each of the plurality of areas and (b) allocating tones to respective pixel electrodes, for each of the plurality of colors, such that chromaticity obtained by all the picture elements in the each of the plurality of areas is not changed even after the reconfiguration; and in the step (iii), in a case where the difference in luminance between the respective adjacent two picture elements in each of the plurality of areas is larger than the predetermined difference, the tones of the respective second plurality of pixel electrodes are reconfigured by (a) averaging luminances of the respective picture elements in the each of the plurality of areas, (b) allocating tones to respective pixel electrodes, for each of the plurality of colors, such that chromaticity obtained by all the picture elements in the each of the plurality of areas is not changed even after the reconfiguration, and then (c) reallocating luminances of the respective adjacent two picture elements by changing tones, by identical tones, of respective pixel electrodes, which are included in each of the adjacent two picture elements and have respective different colors of the plurality of colors, such that the luminances of the respective adjacent two picture elements are not changed even after the reconfiguration.

Here, “reallocating luminances of the respective adjacent two picture elements by changing tones, by identical tones, of respective pixel electrodes, which are included in each of the adjacent two picture elements and have respective different colors of the plurality of colors” means that, in a case where, for example, a tone of the red pixel, which is included in a picture element made up of red, green, and blue pixels, is increased by 10, tones of the respective green and blue pixels are also increased by 10.

In a case where a difference in luminance between respective adjacent two picture elements in the each of the plurality of areas is not larger than a predetermined difference (e.g., not larger than 100 cd/m²), a human hardly visually recognizes a difference in luminance between the respective adjacent two picture elements, even though a luminance of a picture element, which has not been reconfigured, is different from that of a reconfigured picture element. Under the circumstances, according to the configuration or the method of the present invention, in a case where the difference in luminance between respective adjacent two picture elements in the each of the plurality of areas is not larger than a predetermined difference, a difference in chromaticity from the desired chromaticity can be minimized by averaging luminances of the respective picture elements in the each of the plurality of areas.

With the configuration or the method, in a case where the difference in luminance between respective adjacent two picture elements in the each of the plurality of areas is not larger than a predetermined difference, it is possible to make smaller a difference in chromaticity from the desired chromaticity with a simple operation. On the other hand, in a case where the difference in luminance between respective adjacent two picture elements is larger than a predetermined difference, both a color crosstalk and a crosstalk can be improved by making smaller a difference in chromaticity and a difference in luminance from the respective desired chromaticity and luminance.

With the configuration or the method of the present invention, an appropriate process can be carried out depending on a difference in luminance between respective adjacent two picture elements in each of the plurality of areas.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

The present invention is applicable to a high resolution and high definition display device.

1. A display device comprising an active matrix substrate,
the active matrix substrate including:
a plurality of gate lines;
a plurality of source lines provided so as to intersect with the plurality of gate lines;
a first plurality of pixel electrodes each of which is provided (i) between corresponding adjacent two of the plurality of source lines and (ii) between corresponding adjacent two of the plurality of gate lines, each of the first plurality of pixel electrodes being provided for a color of a plurality of colors with which an image is to be constituted; and
a plurality of switching elements provided in the vicinity of respective intersections of the plurality of gate lines and the plurality of source lines, each of the plurality of switching elements being connected with a corresponding one of the plurality of gate lines and a corresponding one of the plurality of source lines,
each of the first plurality of pixel electrodes causing image to be displayed in accordance with a transmittance corresponding to a predetermined tone by electrically connecting (i) the corresponding one of the plurality of source lines which is connected to a corresponding one of the plurality of switching elements with (ii) the each of the first plurality of pixel electrodes when a scanning signal, indicative of instructions on electrical conduction, is supplied to the corresponding one of the plurality of gate lines connected to the corresponding one of the plurality of switching elements,
said display device further comprising:
a reconfiguring section for reconfiguring the tones between respective identical-colored ones of a second plurality of pixel electrodes in each of a plurality of areas into which a display area of said display device is divided, each of the plurality of areas containing the second plurality of pixel electrodes included in the first plurality of pixel electrodes,
the reconfiguring section (i) calculating a first difference between (a) a first tone of a first pixel electrode, which is provided between corresponding adjacent two of the plurality of source lines and is connected with one of the corresponding adjacent two of the plurality of source lines and (b) a second tone of a second pixel electrode connected with the other of the corresponding adjacent two of the plurality of source lines and (ii) reconfiguring tones of the respective second plurality of pixel electrodes such that the first difference becomes smaller than a first difference which has not been reconfigured.

2-4. (canceled)

5. A display device as set forth in claim 1, further comprising:
a tone-luminance converting section for estimating, for each of the plurality of colors, a luminance based on pieces of data indicative of respective tones, which pieces of data are supplied to the respective first plurality of pixel electrodes,
the reconfiguring section selecting a pixel electrode having a highest one of luminances, estimated by the tone-luminance converting section, out of the second plurality of pixel electrodes, and
the reconfiguring section reconfiguring tones of the respective second plurality of pixel electrodes, while fixing a tone of a selected pixel electrode, such that a third difference between (i) the tone of the selected pixel electrode which is (a) provided between adjacent two of the plurality of source lines and (b) connected with one of the adjacent two of the plurality of source lines and (ii) a tone of a pixel electrode connected with the other of the adjacent two of the plurality of source lines, becomes smaller than a third difference that has not been reconfigured.

6. The display device as set forth in claim 5, wherein:
the reconfiguring section reconfigures combinations of tones of the respective second plurality of pixel electrodes such that the third difference becomes a smallest one.

7. The display device as set forth in claim 5, wherein:
the tone-luminance converting section calculates the luminance with reference to a look-up table in which tones are associated with respective output luminances for each of the plurality of colors.

8-9. (canceled)

10. A method for driving a display device,
said display device including an active matrix substrate,
the active matrix substrate including:
a plurality of gate lines;
a plurality of source lines provided so as to intersect with the plurality of gate lines;
a first plurality of pixel electrodes each of which is provided (i) between corresponding adjacent two of the plurality of source lines and (ii) between corresponding adjacent two of the plurality of gate lines, each of the first plurality of pixel electrodes being provided for a color of a plurality of colors with which an image is to be constituted; and
a plurality of switching elements provided in the vicinity of respective intersections of the plurality of gate lines and the plurality of source lines, each of the plurality of switching elements being connected with a corresponding one of the plurality of gate lines and a corresponding one of the plurality of source lines,
each of the first plurality of pixel electrodes causing image to be displayed in accordance with a transmittance corresponding to a predetermined tone by electrically connecting (i) the corresponding one of the plurality of source lines which is connected to a corresponding one of the plurality of switching elements with (ii) the each of the first plurality of pixel electrodes when a scanning signal, indicative of instructions on electrical conduction, is supplied to the corresponding one of the plurality of gate lines connected to the corresponding one of the plurality of switching elements,
said method comprising the steps of:
(i) dividing a display area of said display device into a plurality of areas, each of which contains a second plurality of pixel electrodes included in the first plurality of pixel electrodes;
(ii) calculating a first difference between (a) a first tone of a first pixel electrode, which is provided between corresponding adjacent two of the plurality of source lines and is connected with one of the corresponding adjacent two of the plurality of source lines and (b) a second tone of a second pixel electrode connected with the other of the corresponding adjacent two of the plurality of source lines; and
(iii) reconfiguring the tones between respective identical-colored ones of the second plurality of pixel electrodes in each of the plurality of areas such that the first difference becomes smaller than a first difference which has not been reconfigured.

11. (canceled)

12. A method as set forth in claim 10, further comprising the step of:
(iv) estimating, for each of the plurality of colors, a luminance based on pieces of data indicative of respective tones, which pieces of data are supplied to the respective first plurality of pixel electrodes,
wherein, in the step (iii), a pixel electrode having a highest one of luminances, estimated in the step (iv), is selected out of the second plurality of pixel electrodes, and
tones of the respective second plurality of pixel electrodes are reconfigured, while fixing a tone of a selected pixel electrode, such that a third difference between (a) the tone of the selected pixel electrode which is provided between adjacent two of the plurality of source lines and is connected with one of the adjacent two of the plurality of source lines and (b) a tone of a pixel electrode connected with the other of the adjacent two of the plurality of source lines, becomes smaller than a third difference that has not been reconfigured.

13-14. (canceled)

15. A display device comprising an active matrix substrate,
the active matrix substrate including:
a plurality of gate lines;
a plurality of source lines provided so as to intersect with the plurality of gate lines;
a first plurality of pixel electrodes each of which is provided (i) between corresponding adjacent two of the plurality of source lines and (ii) between corresponding adjacent two of the plurality of gate lines, each of the first plurality of pixel electrodes being provided for a color of a plurality of colors with which an image is to be constituted; and
a plurality of switching elements provided in the vicinity of respective intersections of the plurality of gate lines and the plurality of source lines, each of the plurality of switching elements being connected with a corresponding one of the plurality of gate lines and a corresponding one of the plurality of source lines,
each of the first plurality of pixel electrodes causing image to be displayed in accordance with a transmittance corresponding to a predetermined tone by electrically connecting (i) the corresponding one of the plurality of source lines which is connected to a corresponding one of the plurality of switching elements with (ii) the each of the first plurality of pixel electrodes when a scanning signal, indicative of instructions on electrical conduction, is supplied to the corresponding one of the plurality of gate lines connected to the corresponding one of the plurality of switching elements,
said display device further comprising:
a reconfiguring section for reconfiguring the tones between respective identical-colored ones of a second plurality of pixel electrodes in each of a plurality of areas into which a display area of said display device is divided, each of the plurality of areas containing the second plurality of pixel electrodes included in the first plurality of pixel electrodes,
the reconfiguring section (i) calculating a sum of a first difference between (a) a first tone of a first pixel electrode, which is provided between corresponding adjacent two of the plurality of source lines and is connected with one of the corresponding adjacent two of the plurality of source lines and (b) a second tone of a second pixel electrode connected with the other of the corresponding adjacent two of the plurality of source lines and (ii) reconfiguring tones of the respective second plurality of pixel electrodes such that the sum of the first difference becomes smaller than a sum of a first difference which has not been reconfigured.

16. The display device as set forth in claim 15, wherein:
the reconfiguring section calculates, for each of the plurality of colors, a sum of a second difference between the first and second tones; and
the reconfiguring section reconfigures the tones of the respective second plurality of pixel electrodes such that the sum of the second difference between the plurality of colors becomes smaller than a sum of a second difference which has not been reconfigured.

17. The display device as set forth in claim 16, wherein:
the reconfiguring section reconfigures combinations of tones of the respective second plurality of pixel electrodes such that the sum of the second difference between the plurality of colors becomes a smallest one.

18. The display device as set forth in claim 16, wherein:
the plurality of colors are red, green, and blue; and
the reconfiguring section reconfigures only tones of respective of red pixel electrodes and blue pixel electrodes of the second plurality of pixel electrodes such that the sum of the second difference between the red, green, and blue becomes smaller than a sum of a second difference that has not been reconfigured.

19. The display device as set forth in claim 15, wherein:
the reconfiguring section reconfigures the tones of the respective second plurality of pixel electrodes such that (i) a luminance of a picture element is not changed even after the reconfiguration and (ii) chromaticity obtained by all picture elements in the each of the plurality of areas is not changed even after the reconfiguration.

20. The display device as set forth in claim 15, wherein:
in a case where a difference in luminance between respective adjacent two picture elements in the each of the plurality of areas is not larger than a predetermined difference, the reconfiguring section reconfigures tones of the respective second plurality of pixel electrodes by (i) averaging luminances of respective picture elements in the each of the plurality of areas and (ii) allocating tones to respective pixel electrodes, for each of the plurality of colors, such that chromaticity obtained by all the picture elements in the each of the plurality of areas is not changed even after the reconfiguration; and
in a case where the difference in luminance between the respective adjacent two picture elements in each of the plurality of areas is larger than the predetermined difference, the reconfiguring section reconfigures the tones of the respective second plurality of pixel electrodes by (i) averaging luminances of the respective picture elements in the each of the plurality of areas, (ii) allocating tones to respective pixel electrodes, for each of the plurality of colors, such that chromaticity obtained by all the picture elements in the each of the plurality of areas is not changed even after the reconfiguration, and then (iii) reallocating luminances of the respective adjacent two picture elements by changing tones, by identical tones, of respective pixel electrodes, which are included in each of the adjacent two picture elements and have respective different colors of the plurality of colors, such that the luminances of the respective adjacent two picture elements are not changed even after the reconfiguration.

21. A method for driving a display device,
said display device including an active matrix substrate,
the active matrix substrate including:
a plurality of gate lines;
a plurality of source lines provided so as to intersect with the plurality of gate lines;
a first plurality of pixel electrodes each of which is provided (i) between corresponding adjacent two of the plurality of source lines and (ii) between corresponding adjacent two of the plurality of gate lines, each of the first plurality of pixel electrodes being provided for a color of a plurality of colors with which an image is to be constituted; and
a plurality of switching elements provided in the vicinity of respective intersections of the plurality of gate lines and the plurality of source lines, each of the plurality of switching elements being connected with a corresponding one of the plurality of gate lines and a corresponding one of the plurality of source lines,
each of the first plurality of pixel electrodes causing image to be displayed in accordance with a transmittance corresponding to a predetermined tone by electrically connecting (i) the corresponding one of the plurality of source lines which is connected to a corresponding one of the plurality of switching elements with (ii) the each of the first plurality of pixel electrodes when a scanning signal, indicative of instructions on electrical conduction, is supplied to the corresponding one of the plurality of gate lines connected to the corresponding one of the plurality of switching elements,
said method comprising the steps of:
(i) dividing a display area of said display device into a plurality of areas, each of which contains a second plurality of pixel electrodes included in the first plurality of pixel electrodes;
(ii) calculating a sum of a first difference between (a) a first tone of a first pixel electrode, which is provided between corresponding adjacent two of the plurality of source lines and is connected with one of the corresponding adjacent two of the plurality of source lines and (b) a second tone of a second pixel electrode connected with the other of the corresponding adjacent two of the plurality of source lines; and
(iii) reconfiguring the tones between respective identical-colored ones of the second plurality of pixel electrodes in each of the plurality of areas such that the sum of the first difference becomes smaller than a sum of a first difference which has not been reconfigured.

22. The method as set forth in claim 21, wherein:
in the step (iii), the tones of the respective second plurality of pixel electrodes are reconfigured based on a sum of a second difference between the first and second tones calculated for each of the plurality of colors; and
the reconfiguration is carried out such that the sum of the second difference between the plurality of colors becomes smaller than a sum of a second difference which has not been reconfigured.

23. The method as set forth in claim 21, wherein:
in the step (iii), the tones of the respective second plurality of pixel electrodes are reconfigured such that (a) a luminance of a picture element is not changed even after the reconfiguration and (b) chromaticity obtained by all picture elements in the each of the plurality of areas is not changed even after the reconfiguration.

24. The method as set forth in claim 21, wherein:
in the step (iii), in a case where a difference in luminance between respective adjacent two picture elements in the each of the plurality of areas is not larger than a predetermined difference, tones of the respective second plurality of pixel electrodes are reconfigured by (a) averaging luminances of respective picture elements in the each of the plurality of areas and (b) allocating tones to respective pixel electrodes, for each of the plurality of colors, such that chromaticity obtained by all the picture elements in the each of the plurality of areas is not changed even after the reconfiguration; and
in the step (iii), in a case where the difference in luminance between the respective adjacent two picture elements in each of the plurality of areas is larger than the predetermined difference, the tones of the respective second plurality of pixel electrodes are reconfigured by (a) averaging luminances of the respective picture elements in the each of the plurality of areas, (b) allocating tones to respective pixel electrodes, for each of the plurality of colors, such that chromaticity obtained by all the picture elements in the each of the plurality of areas is not changed even after the reconfiguration, and then (c) reallocating luminances of the respective adjacent two picture elements by changing tones, by identical tones, of respective pixel electrodes, which are included in each of the adjacent two picture elements and have respective different colors of the plurality of colors, such that the luminances of the respective adjacent two picture elements are not changed even after the reconfiguration.
